(19) United States
(12) Patent Application Publication
(10) Pub. No.: US 2025/0261227 A1
(43) Pub. Date: Aug. 14, 2025

(54) RANDOM ACCESS PROCEDURES WITH A VIRTUAL CELL

(71) Applicant: QUALCOMM Incorporated, San Diego, CA (US)

(72) Inventors: Jing LEI, San Diego, CA (US); Kazuki TAKEDA, Minato-ku (JP); Kianoush HOSSEINI, San Diego, CA (US)

(21) Appl. No.: 18/439,377

(22) Filed: Feb. 12, 2024

(51) Int. Cl. H04W 74/00; H04W 74/0833

(52) U.S. Cl. CPC H04W 74/006; H04W 74/0833

(57) ABSTRACT

Methods, systems, and devices for wireless communications are described. A user equipment (UE) may receive one or more control messages from a network entity that include a sub-band index and a parameter associated with a quantity of random access (RA) occasions. The UE may transmit an RA message to the network entity via an RA occasion of a specific sub-band based on the sub-band index and the parameter. The UE may receive, from the network entity, a random access response (RAR) message that is associated with the index of the sub-band, the RA occasion, or both. In some examples, the RAR message may be associated with a sub-band based on including the sub-band index, the parameter, or both in one or more portions of the RAR message.

### FIELD OF TECHNOLOGY

The following relates to wireless communications, including random access procedures with a virtual cell.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support random access procedures with a virtual cell. For example, the described techniques may enable devices of a wireless communications network to perform random access (RA) procedures based on sub-band configurations of a virtual cell. In some examples, a user equipment (UE) may receive, from a network entity, one or more control messages that include a sub-band index and one or more parameters (e.g., a parameter associated with a quantity of random access occasions). Accordingly, the UE may perform a random access procedure in accordance with the sub-band index and the one or more parameters indicated via the one or more control messages. In some examples, the UE may transmit, to the network entity, a random access message via resources of a specific sub-band based on the sub-band index and the one or more parameters. The UE may receive, in response from the network entity, a random access response (RAR) message, that is associated with the specific sub-band. In some examples, the RAR message may be associated with a sub-band based on including a sub-band index and/or one or more parameters (e.g., in a control channel portion of a RAR, in a shared channel portion of a RAR, or both). Such techniques may improve communication reliability in a wireless communications system by supporting enhanced random access procedures that account for various sub-band configurations (e.g., for fragmented spectrum and virtual cell environments).

A method for wireless communications by a UE is described. The method may include receiving a control message that includes an index of a sub-band of a set of multiple sub-bands of a virtual cell and a quantity of RA occasions associated with the sub-band, transmitting a RA message within a RA occasion of the quantity of RA occasions indicated by the control message, and receiving a RAR message that is associated with the index of the sub-band, the RA occasion, or both after transmitting the RA message.

A UE for wireless communications is described. The UE may include one or more memories storing processor executable code, and one or more processors coupled with the one or more memories. The one or more processors may individually or collectively operable to execute the code to cause the UE to receive a control message that includes an index of a sub-band of a set of multiple sub-bands of a virtual cell and a quantity of RA occasions associated with the sub-band, transmit a RA message within a RA occasion of the quantity of RA occasions indicated by the control message, and receive an RAR message that is associated with the index of the sub-band, the RA occasion, or both after transmitting the RA message.

Another UE for wireless communications is described. The UE may include means for receiving a control message that includes an index of a sub-band of a set of multiple sub-bands of a virtual cell and a quantity of RA occasions associated with the sub-band, means for transmitting an RA message within an RA occasion of the quantity of RA occasions indicated by the control message, and means for receiving an RAR message that is associated with the index of the sub-band, the RA occasion, or both after transmitting the RA message.

A non-transitory computer-readable medium storing code for wireless communications is described. The code may include instructions executable by one or more processors to receive a control message that includes an index of a sub-band of a set of multiple sub-bands of a virtual cell and a quantity of RA occasions associated with the sub-band, transmit an RA message within an RA occasion of the quantity of RA occasions indicated by the control message, and receive an RAR message that is associated with the index of the sub-band, the RA occasion, or both after transmitting the RA message.

In some examples of the method, UEs, and non-transitory computer-readable medium described herein, transmitting the RA message may include operations, features, means, or instructions for transmitting the RA message in accordance with a first index, where the first index may be based on combining the quantity of RA occasions with one or more second quantities of RA occasions associated with one or more second sub-bands.

Some examples of the method, UEs, and non-transitory computer-readable medium described herein may further include operations, features, means, or instructions for selecting a second index of the RA occasion based on the index of the sub-band and the quantity of RA occasions, where the first index may be based on combining the second index with the combined quantity of RA occasions, and where the second index may be a sub-band specific index and the first index may be a non-sub-band specific index.

Some examples of the method, UEs, and non-transitory computer-readable medium described herein may further include operations, features, means, or instructions for transmitting the RA message in accordance with a temporary identifier, the temporary identifier being associated with a first type of RA procedure and the first index, where the temporary identifier may be different than one or more second temporary identifiers associated with a second type of RA procedure based on the first index.

In some examples of the method, UEs, and non-transitory computer-readable medium described herein, receiving the RAR message may include operations, features, means, or instructions for receiving a second control message associated with the RAR message based on transmitting the RA message, where the RAR message may be associated with the index of the sub-band, the RA occasion, or both based on receiving the second control message.

In some examples of the method, UEs, and non-transitory computer-readable medium described herein, the second control message includes one or more fields that indicate the index of the sub-band, the RA occasion, or both.

Some examples of the method, UEs, and non-transitory computer-readable medium described herein may further include operations, features, means, or instructions for decoding the second control message in accordance with the index of the sub-band, the RA occasion, or both based on one or more cyclic redundancy check bits of the second control message, a reference signal scrambling identifier of the second control message, a bit interleaving pattern of the second control message, or any combination thereof, where receiving the RAR message may be based on decoding the second control message.

In some examples of the method, UEs, and non-transitory computer-readable medium described herein, receiving the RAR message may include operations, features, means, or instructions for receiving, via the RAR message, an indication of the index of the sub-band, an indication of the RA occasion, or both.

In some examples of the method, UEs, and non-transitory computer-readable medium described herein, receiving the indication may include operations, features, means, or instructions for receiving the indication of the index of the sub-band, the indication of the RA occasion of the RAR message, or both via a medium access control (MAC) header of the RAR message, a MAC payload, one or more padding bits of the RAR message, a reference signal scrambling identifier of the RAR message, or a combination thereof.

In some examples of the method, UEs, and non-transitory computer-readable medium described herein, receiving the RAR message may include operations, features, means, or instructions for receiving the RAR message in accordance with the index of the sub-band, the RA occasion, or both based on first information included in a second control message associated with the RAR message and second information included in the RAR message.

In some examples of the method, UEs, and non-transitory computer-readable medium described herein, the quantity of RA occasions may be based on a type of RA procedure.

In some examples of the method, UEs, and non-transitory computer-readable medium described herein, at least a first sub-band of the set of multiple sub-bands and a second sub-band of the set of multiple sub-bands may be non-contiguous in a frequency domain.

A method for wireless communications by a network entity is described. The method may include outputting a control message that includes an index of a sub-band of a set of multiple sub-bands of a virtual cell and a quantity of RA occasions associated with the sub-band, obtaining an RA message within an RA occasion of the quantity of RA occasions indicated by the control message, and outputting, to a UE, an RAR message that is associated with the index of the sub-band, the RA occasion, or both after obtaining the RA message.

A network entity for wireless communications is described. The network entity may include one or more memories storing processor executable code, and one or more processors coupled with the one or more memories. The one or more processors may individually or collectively operable to execute the code to cause the network entity to output a control message that includes an index of a sub-band of a set of multiple sub-bands of a virtual cell and a quantity of RA occasions associated with the sub-band, obtain an RA message within an RA occasion of the quantity of RA occasions indicated by the control message, and output, to a UE, an RAR message that is associated with the index of the sub-band, the RA occasion, or both after obtaining the RA message.

Another network entity for wireless communications is described. The network entity may include means for outputting a control message that includes an index of a sub-band of a set of multiple sub-bands of a virtual cell and a quantity of RA occasions associated with the sub-band, means for obtaining an RA message within an RA occasion of the quantity of RA occasions indicated by the control message, and means for outputting, to a UE, an RAR message that is associated with the index of the sub-band, the RA occasion, or both after obtaining the RA message.

A non-transitory computer-readable medium storing code for wireless communications is described. The code may include instructions executable by one or more processors to output a control message that includes an index of a sub-band of a set of multiple sub-bands of a virtual cell and a quantity of RA occasions associated with the sub-band, obtain an RA message within an RA occasion of the quantity of RA occasions indicated by the control message, and output, to a UE, an RAR message that is associated with the index of the sub-band, the RA occasion, or both after obtaining the RA message.

In some examples of the method, network entities, and non-transitory computer-readable medium described herein, obtaining the RA message may include operations, features, means, or instructions for obtaining the RA message in accordance with a first index, where the first index may be based on a combination of the quantity of RA occasions with one or more second quantities of RA occasions associated with one or more second sub-bands.

In some examples of the method, network entities, and non-transitory computer-readable medium described herein, the first index may be based on a combination of a second index of the RA occasion and the combined quantity of RA occasions, the second index based on the index of the sub-band and the quantity of RA occasions and the second index may be a sub-band specific index and the first index may be a non-sub-band specific index.

Some examples of the method, network entities, and non-transitory computer-readable medium described herein may further include operations, features, means, or instructions for obtaining the RA message in accordance with a temporary identifier, the temporary identifier being associated with a first type of RA procedure and the first index, where the temporary identifier may be different than one or more second temporary identifiers associated with a second type of RA procedure based on the first index.

In some examples of the method, network entities, and non-transitory computer-readable medium described herein, outputting the RAR message may include operations, features, means, or instructions for outputting a second control message associated with the RAR message based on obtaining the RA message, where the RAR message may be associated with the index of the sub-band, the RA occasion, or both based on outputting the second control message.

In some examples of the method, network entities, and non-transitory computer-readable medium described herein, the second control message includes one or more fields that indicate the index of the sub-band, the RA occasion, or both.

Some examples of the method, network entities, and non-transitory computer-readable medium described herein may further include operations, features, means, or instructions for encoding the second control message in accordance with the index of the sub-band, the RA occasion, or both based on one or more cyclic redundancy check bits of the second control message, a reference signal scrambling identifier of the second control message, a bit interleaving pattern of the second control message, or any combination thereof.

In some examples of the method, network entities, and non-transitory computer-readable medium described herein, outputting the RAR message may include operations, features, means, or instructions for outputting, via the RAR message, an indication of the index of the sub-band, an indication of the RA occasion, or both.

In some examples of the method, network entities, and non-transitory computer-readable medium described herein, outputting the indication may include operations, features, means, or instructions for outputting the indication of the index of the sub-band, the indication of the RA occasion of the RAR message, or both via a MAC header of the RAR message, a MAC payload, one or more padding bits of the RAR message, a reference signal scrambling identifier of the RAR message, or a combination thereof.

In some examples of the method, network entities, and non-transitory computer-readable medium described herein, outputting the RAR message may include operations, features, means, or instructions for outputting the RAR message in accordance with the index of the sub-band, the RA occasion, or both based on including first information in a second control message associated with the RAR message and second information in the RAR message.

In some examples of the method, network entities, and non-transitory computer-readable medium described herein, the quantity of RA occasions may be based on a type of RA procedure.

In some examples of the method, network entities, and non-transitory computer-readable medium described herein, at least a first sub-band of the set of multiple sub-bands and a second sub-band of the set of multiple sub-bands may be non-contiguous in a frequency domain.

### BRIEF DESCRIPTION OF THE DRAWINGS

FIG. 1 shows an example of a wireless communications system that supports random access procedures with a virtual cell in accordance with one or more aspects of the present disclosure.

FIG. 2 shows an example of a wireless communications system that supports random access procedures with a virtual cell in accordance with one or more aspects of the present disclosure.

FIG. 3 shows an example of a message structure that supports random access procedures with a virtual cell in accordance with one or more aspects of the present disclosure.

FIG. 4 shows an example of a process flow that supports random access procedures with a virtual cell in accordance with one or more aspects of the present disclosure.

FIGS. 5 and 6 show block diagrams of devices that support random access procedures with a virtual cell in accordance with one or more aspects of the present disclosure.

FIG. 7 shows a block diagram of a communications manager that supports random access procedures with a virtual cell in accordance with one or more aspects of the present disclosure.

FIG. 8 shows a diagram of a system including a device that supports random access procedures with a virtual cell in accordance with one or more aspects of the present disclosure.

FIGS. 9 and 10 show block diagrams of devices that support random access procedures with a virtual cell in accordance with one or more aspects of the present disclosure.

FIG. 11 shows a block diagram of a communications manager that supports random access procedures with a virtual cell in accordance with one or more aspects of the present disclosure.

FIG. 12 shows a diagram of a system including a device that supports random access procedures with a virtual cell in accordance with one or more aspects of the present disclosure.

FIGS. 13 through 18 show flowcharts illustrating methods that support random access procedures with a virtual cell in accordance with one or more aspects of the present disclosure.

### DETAILED DESCRIPTION

Some wireless communications systems may utilize virtual cells to support a fragmented frequency spectrum, which may enable next generation radio access technologies (RATs) to improve utilization efficiency while satisfying bandwidth constraints. For instance, a virtual cell may include a set of multiple sub-bands (e.g., uplink sub-bands, downlink sub-bands) that may be non-contiguous in a frequency domain (e.g., may occupy non-contiguous frequency resources). The set of sub-bands may include one or more sub-bands (e.g., for different uplink bandwidth parts (BWPs)) that occupy at least a portion of same frequency resources (e.g., respective sub-bands may overlap with one another). Moreover, to support random access (RA) procedures, a network entity may configure one or more physical random access channel (PRACH) occasions (ROs) for each respective sub-band of a virtual cell. However, some RA procedures may not consider overlapping resources between multiple sub-bands. For instance, each sub-band may be associated with a respective set of ROs and random access response (RAR) messages (e.g., from a network entity) may be based on an RO index. However, ROs of different sub-bands may be associated with a same RO indexing. Thus, different user equipments (UEs) operating on different sub-bands may each select an RO with a same index, which may result in conflicting (e.g., ambiguous) RAR messages. Thus, performing such RA procedures via a virtual cell may result in increased processing complexity, increased latency, and increased energy consumption.

In accordance with one or more techniques described herein, a wireless communications system may support enhanced RA procedures to resolve conflicts (e.g., collisions, contentions) associated with one or more sub-bands of a virtual cell. In some examples, a network entity may transmit (e.g., output) one or more control messages to a UE that indicates (e.g., identifies, conveys) a sub-band index and a frequency division multiplexing (FDM) parameter (e.g., a quantity of ROs) configured for the sub-band. A UE may select (e.g., derive, calculate, determine) an RO index based on the sub-band index and the FDM parameter. The selected index may be a unique across all sub-bands of the virtual cell (e.g., an accumulative RO index). Additionally, or alternatively, a network entity may associate a RAR message to a specific sub-band RO (e.g., to a target UE operating on a specific sub-band) based on including a sub-band index and/or a sub-band specific RO index in one or more fields of a control message (e.g., a physical downlink control channel (PDCCH) message) associated with the RAR message. Additionally, or alternatively, the network may associate the RAR message to a sub-band specific RO by including the sub-band index and/or the sub-band specific RO index in one or more portions of a shared channel message (e.g., a physical downlink shared channel (PDSCH) message) associated with the RAR message. Thus, a wireless communications system may be configured to account for (e.g., resolve) conflicts in RA procedures associated with virtual cells, which may provide support for next generation RATs and may result in improved communication reliability, improved coordination between devices, and reduced latency, among other benefits.

Aspects of the disclosure are initially described in the context of wireless communications systems. Aspects of the disclosure are further illustrated by and described with reference to message structures, process flows, apparatus diagrams, system diagrams, and flowcharts that relate to RA procedures with a virtual cell.

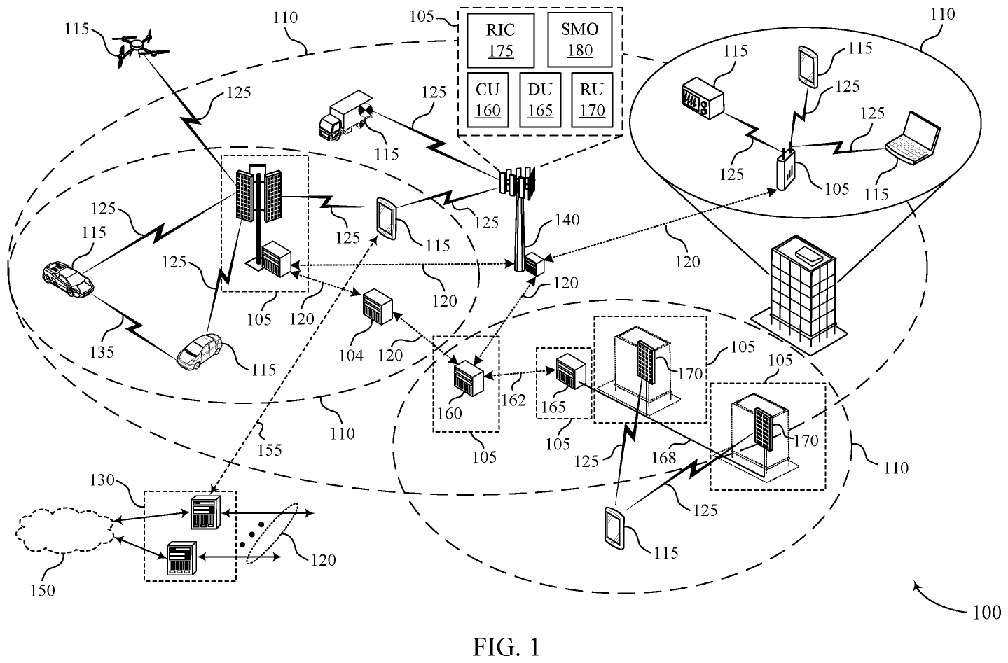

FIG. 1 shows an example of a wireless communications system 100 that supports RA procedures with a virtual cell in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support RA procedures with a virtual cell as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications systems 100 (e.g., some network entities 105) may utilize virtual cells to support a fragmented frequency spectrum, which may enable next generation RATs to improve utilization efficiency while satisfying bandwidth constraints. For instance, a virtual cell (e.g., of one or more network entities 105) may allocate a set of multiple sub-bands (e.g., uplink BWPs, downlink BWPs) that may be non-contiguous in a frequency domain (e.g., may not occupy contiguous frequency resources). At least some of the sub-bands of the set may overlap with one another in a frequency domain. However, some RA procedures of the wireless communications system 100 may not account for such overlapping frequency resources in different sub-bands. For instance, a RAR message may be based on an RO index. Due to the non-contiguous characteristic of one or more sub-bands, different ROs associated with different sub-bands may correspond to a same RO index and may result in conflicting (e.g., ambiguous) RAR messages. Thus, utilizing virtual cells may result in increased processing complexity, increased latency, and increased energy consumption.

In accordance with one or more techniques described herein, a wireless communications system 100 may resolve conflicts associated with RA procedures associated with non-contiguous sub-bands of a virtual cell. In some examples, a network entity 105 may transmit one or more control messages to a UE 115 that indicates a sub-band index and a frequency division multiplexing (FDM) parameter (e.g., a quantity of ROs) configured for the sub-band. A UE 115 may derive an RO index based on the sub-band index and the FDM parameter. The derived index may be a unique across all sub-bands of the virtual cell (e.g., an accumulative RO index). Additionally, or alternatively, a network entity may associate a RAR message to a sub-band specific RO based on including a sub-band index and/or a sub-band specific RO index in one or more portions of a control message (e.g., a PDDCH portion of the RAR message) message associated with the RAR message. Additionally, or alternatively, the network may associate the RAR message to a sub-band specific RO by including the sub-band index and/or the sub-band specific RO index in one or more portions of a shared channel message (e.g., a PDSCH portion of the RAR message). Thus, a wireless communications system 100 may be configured to resolve potential conflicts in RA procedures associated with virtual cells, which may result in improved communication reliability, improved coordination between devices, and reduced latency, among other benefits.

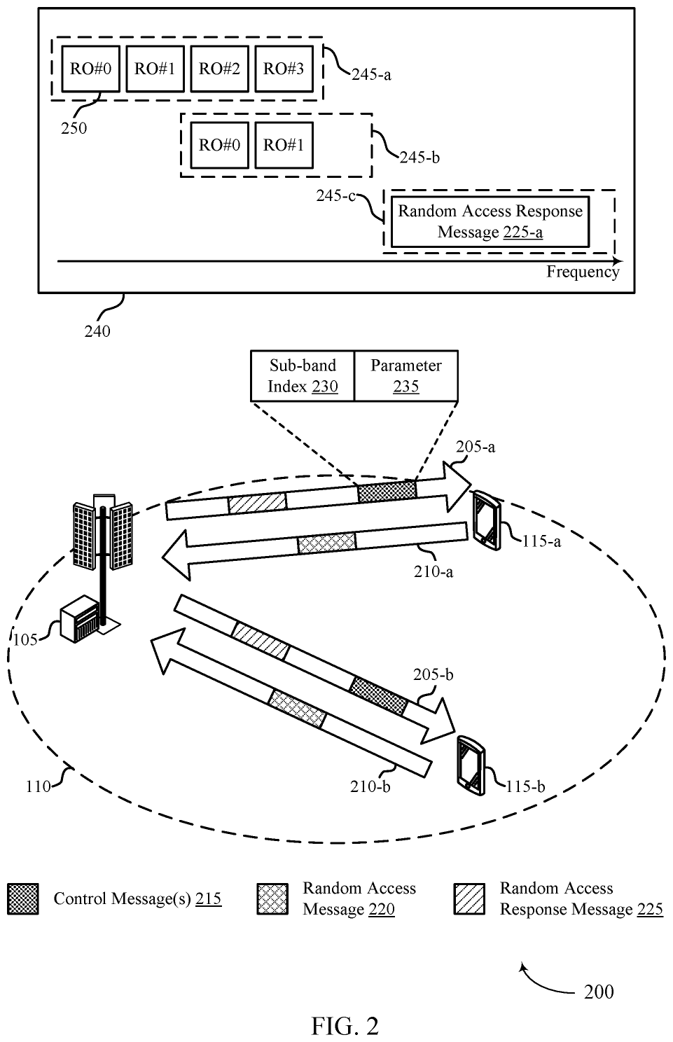

FIG. 2 shows an example of a wireless communications system 200 that supports RA procedures with a virtual cell in accordance with one or more aspects of the present disclosure. The wireless communications system 200 may implement or be implemented by aspects of the wireless communications system 100 as described with reference to FIG. 1. For example, the wireless communications system 200 may include a network entity 105 and one or more UEs 115 within a coverage area 110, which may be examples corresponding devices as described with reference to FIG. 1. For example, the network entity 105 may communicate with a UE 115-a and a UE 115-b via respective communication links 205 (e.g., uplink communication link 205-a and uplink communication link 205-b) and communication links 210 (e.g., downlink communication link 210-a and downlink communication link 210-b). The communication links 205 and the communication links 210 may be examples of or include downlink communication interfaces, uplink communication interfaces, or other communication interfaces. In some examples, the wireless communications system 200 may support enhanced RA procedures (e.g., for virtual cell environments, type 1 RA procedures, type 2 RA procedures) based on signaling between the network entity 105 and one or more UEs 115 including one or more control messages 215, one or more RA messages 220 (e.g., PRACH messages), one or more RAR messages 225, and other messages. Although a network entity 105, a UE 115-a are shown as example devices of the wireless communications system 200, the disclosed techniques may be applied by any combination of devices described herein (e.g., including any quantity of UEs 115, network entities 105, or other devices).

The wireless communications system 200 may support a fragmented spectrum (e.g., a fragmented frequency spectrum), and the devices of the wireless communications system 200 may communicate via one or more component carriers (CCs). In some cases (e.g., for a cell site with one or more CCs), a bandwidth (e.g., a system bandwidth) of each CC may span a set of RBs that are contiguous in a frequency domain. Accordingly, the bandwidth for each CC may be constrained (e.g., lower bounded) by a threshold (e.g., minimum) channel bandwidth of a UE 115. The threshold channel bandwidth of UE may be based on a RAT (e.g., RAT-dependent) and may be preconfigured (e.g., hard-coded) for each operating band (e.g., 1.4 MHz for LTE, May 10, 2020 MHz (subcarrier spacing (SCS) and band dependent) for NR frequency range one (FR1)).

A frequency spectrum of the wireless communications system 200 (e.g., of the fragmented spectrum) may include refarmed spectrum (e.g., frequency spectrum that may be repurposed from other RATs). The refarmed spectrum may be associated with a relatively narrow bandwidth and may be scattered (e.g., non-contiguous) in the frequency domain. Thus, it may be challenging to leverage such resources (e.g., frequency spectrum resources) for dynamic spectrum sharing (e.g., or carrier aggregation (CA) techniques). For example, without a spectrum aggregation with other CCs to meet threshold (e.g., minimum) channel bandwidth constraints, one or more refarmed CCs (e.g., associated with bandwidths of less than 5 MHz) may not be suitable for standalone (SA) deployment (e.g., of NR/5G).

In some cases, the wireless communications system 200 may support virtual cells to integrate fragmented spectrum (e.g., refarmed from another RAT). A virtual cell may include one or more sub-bands (e.g., RB groups, an aggregation of one or more non-contiguous sub-bands), which may provide increased flexibility to the wireless communications system 200. For instance, the one or more sub-bands may be configured to overcome a constraint associated with spectrum refarming and CA techniques (e.g., based on limited bandwidth), improve the utilization efficiency of fragmented (e.g., refarmed) resources, and enhance a co-existence of different UE types or use cases in the wireless communications system 200.

In some cases, a pair of downlink and uplink BWPs may be configured for the virtual cell. The downlink BWP, the uplink BWP, or both may include one or more sub-bands, which may be non-contiguous in the frequency domain. In some cases, the downlink BWP may occupy common resources across all BWP configurations (e.g., to reduce complexity in cell searching or other broadcast signal processing). Moreover, center frequencies for downlink BWPs and uplink BWPs may not be aligned. As a non-limiting example, a virtual cell may include a first sub-band (e.g., that includes a 3 MHz frequency band and a 1.4 MHz frequency band), a second sub-band (e.g., that includes three 1.4 MHz frequency bands), and a third sub-band (e.g., that includes a 5 MHz frequency band). In a first configuration, a first uplink BWP may include the first sub-band and the second sub-band, and a first downlink BWP may include the third sub-band. In a second configuration, a second uplink BWP may include the first sub-band, and a second downlink BWP may include the third sub-band. In a third configuration, a third uplink BWP may include each of the first sub-band, the second sub-band, and the third sub-band, and a third downlink BWP may include the third sub-band (e.g., the third downlink BWP may be fully contained within the bandwidth of the third uplink BWP). Thus, some systems (e.g., sixth generation (6G) systems) may support various BWP configurations including virtual cells that include various sub-bands, which may overlap in a frequency domain (e.g., may occupy the same resources).

To support RA procedures (e.g., by a UE 115), a network entity 105 may configure one or more ROs 250 on one or more sub-bands of a virtual cell. For instance, one or more UEs 115 may transmit an RA message 220 to the network entity 105, and the network entity 105 may respond with a RAR message 225. In some cases, a configuration of a RAR message 225 (e.g., a random access-radio network temporary identifier (RA-RNTI) calculation, a msgB-radio network temporary identifier (RNTI) calculation) may be based on RO indexing within an active uplink BWP (e.g., a BWP-specific RO index in the frequency domain). However, in the presence of multiple BWPs configured across various sub-bands of a virtual cell, such methods may result in conflicts between RA procedures associated with different BWPs (e.g., between RACH procedures of different UEs). For instance, different ROs 250 that occupy different time and frequency resources may be mapped to a same RO index in a frequency domain, and thus, may be associated with a same RAR message configuration (e.g., a same RA-RNTI or msgB-RNTI).

As an illustrative example, the network entity 105 and the UEs 115 may utilize a resource configuration 240. A UE 115-a may operate on a first uplink BWP 245-a of a virtual cell (e.g., associated with one or more network entities 105), and a UE 115-b may operate on a second uplink BWP 245-b of the virtual cell. The first uplink BWP 245-a may be configured with, for example, four ROs 250 (e.g., frequency division multiplexed (FDM) ROs for a four-step RA procedure at one time instance, RO #0, RO #1, RO #2, and RO #3). The second uplink BWP 245-b may be configured with, for example, two ROs 250 (e.g., FDM ROs for a two-step RA procedure at one time instance, RO #0, RO #1), which may at least partially overlap with the ROs 250 configured in the first uplink BWP 245-a. The UE 115-a may select RO #0 (e.g., a preamble identifier) of the first uplink BWP 245-a to use for transmission of an RA message 220. Additionally, the UE 115-b may select RO #0 (e.g., a same preamble identifier) of the second uplink BWP 245-b to use of transmission of an RA message 220. That is, both the UE 115-a and the UE 115-b may select ROs 250 that are associated with a same RO index (e.g., #0).

However, because a RAR message 225 may be based on an RO index a same RAR message 225-a (e.g., on a same downlink BWP 245-c) may be configured for (e.g., linked to) the first uplink BWP 245-a and the second uplink BWP 245-b (e.g., a same RA-RNTI for RO #0). That is, different ROs 250 on different frequency resources may be mapped to a same RA-RNTI (e.g., may collide). Thus, both the UE 115-a and the UE 115-b may monitor for a same RAR message 225-a (e.g., an RAR message 225 scheduled by a same RA-RNTI on the downlink BWP 245-c), which may result in a collision in reception of the RAR message 225-a (e.g., even though there may be no resource collision between the resource selection between the UE 115-a and the UE 115-b). In another example, the UE 115-a may select a first preamble identifier on RO #1 of the first uplink BWP 245-a, and the UE 115-b may select a second preamble (e.g., different from the first preamble) on RO #1 of the second uplink BWP 245-b. Accordingly, the UE 115-a (e.g., or the UE 115-b) may attempt to decode a message (e.g., a PDCCH message and a PDSCH message) targeting the UE 115-b (e.g., or the UE 115-a) if the network entity 105 is not able to align a timeline of PRACH processing for different ROs 250 (e.g., resulting in uplink interference between UEs 115). Such methods may result in additional complexity of network entity 105 and UE 115 implementation and may adversely affect a latency profile and a power profile of UEs 115 operating on different UL BWPs 245 of the virtual cell.

In accordance with techniques described herein, the wireless communications system 200 and the devices therein may support methods to improve RA procedures and reduce message contention (e.g., collision). In some examples, the wireless communications system 200 may support a joint indication of a sub-band index 230 and a parameter 235 (e.g., an FDM parameter 235, or one or more parameters 235). An uplink carrier (e.g., an uplink BWP 245) of a virtual cell may include a quantity of sub-bands (e.g., Nᵤ>0 sub-bands), and the sub-bands may be ordered sequentially in an ascending order of frequency (e.g., when Nᵤ>1). If a sub-band on the virtual cell is configured for both an uplink carrier and a downlink carrier, the sub-band index 230 associated with uplink carrier may be different from the sub-band index 230 associated with downlink carrier.

In some examples, a UE may calculate an RO index in the frequency domain based on one or more FDM parameters 235 of ROs 250 and one or more sub-band indexes 230. For example, if a sub-band of the uplink carrier is configured with ROs 250 for an RA procedure (e.g., of Type-Q), the network entity 105 may communicate (e.g., indicate, convey, transmit) the FDM parameter 235 and the sub-band index 230 to a UE 115 via one or more control messages 215 (e.g., one or more system information (SI) messages, one or more RRC messages). The sub-band index 230 may be a sub-band specific index, l, where l∈{0, 1, . . . , total quantity of sub-bands configured for the UL carrier of a virtual cell−1}. The FDM parameter 235 may be a quantity of FDM ROs 250 configured for an RA procedure (e.g., of Type Q) on a sub-band, l, which may be represented as N_{Q}^{l} (e.g., N_{Q}^{l}>0).

An RA procedure may be a four-step RA procedure (e.g., Q=1) or a two-step RA procedure (e.g., Q=2). If a sub-band of an uplink carrier is not configured with ROs 250 for RA procedure of Type-Q, the quantity of FDM ROs 250 may be set to 0, or may not be provided to a UE 115 (e.g., N_{Q}^{l}=0 if the FDM parameter 235 of ROs 250 is not provided for RA procedure of Type-Q). Accordingly, the wireless communications system 200 may support unique indexing for ROs 250 of respective sub-bands (e.g., sub-band specific RO indexing). For example, if a sub-band l is configured with N_{Q}^{l}>0 ROs 250 for Type-Q RA procedure, the N_{Q}^{l} ROs 250 may be ordered in an ascending order of frequency (e.g., as 0, 1, . . . , n_{l,Q}, . . . , N_{Q}^{l}−1). In such examples, n_{l,Q} may be a sub-band specific RO index on sub-band l, which may be configured for a type-Q RA procedure (e.g., 0≤n_{l,Q}≤N_{Q}^{l}−1).

In some examples, the sub-band index 230 and the FDM parameter 235 may support accumulative (e.g., absolute) RO indexing in a frequency domain (e.g., indexing of ROs 250 that considers ROs 250 across multiple BWPs). For example, a UE 115 may select an RO 250 indexed by n_{l,Q} from sub-band l to perform an RA procedure of type-Q. An accumulative RO index in a frequency domain (e.g., F_{id,Q}) may be calculated according to Equation 1.

$${F}_{id , Q} = {n}_{l , Q} + {\sum }_{k = 0}^{l - 1} {N}_{Q}^{k} \qquad Equation 1$$

In Equation 1, n_{l,Q} may be a sub-band specific RO index for sub-band l of an uplink carrier, where 0≤n_{l,Q}≤N_{Q}^{l}. In some examples, if a sub-band k of the uplink carrier is not configured with an RO 250 for a type-Q RA procedure, N_{Q}^{k}=0. Accordingly, by applying a calculation in accordance with Equation 1, a UE 115 (e.g., and a network entity 105) may determine an accumulative RO index. The accumulative RO index may be based on combining each RO 250 over the quantity (e.g., range) of ROs 250 indicated by the parameter 235 (e.g., N_{Q}^{l}, based on the summation operation of Equation 1) as well as the selected RO associated with the sub-band index 230 (e.g., n_{l,Q}, based on the addition of n_{l,Q} in Equation 1). In such examples, a group RNTI for Type-Q RA procedure may be calculated based on F_{id,Q}, (e.g., the accumulative RO index in the frequency domain).

If an RO 250 is common among (e.g., shared by) multiple types of RA procedures, the accumulative RO index in the frequency domain may separately calculated for each type of RA procedure. In some examples, a range of group RNTI (e.g., M bits, M≥16) for different types of RA procedure may not overlap (e.g., may occupy different ranges of group RNTI values). The accumulative RO index may account for various ROs 250 spread across different uplink BWPs 245 (e.g., based on utilizing Equation 1). As a non-limiting example, Equation 1 may produce different indexes (e.g., and thus different RNTIs) for the RO #0 of the first uplink BWP 245-a and for RO #0 of the second uplink BWP 245-b. That is, the two RO #0s configured for a same type of RA procedure (e.g., Type-1 RA) may be mapped to different locations in the frequency domain, which may correspond to different values of the accumulative RO index in the frequency domain. As another non-limiting example, Equation 1 may produce a same index (e.g., and thus a same RNTI) for RO #2 of the first uplink BWP 245-a and for RO #0 of the second uplink BWP 245-b. That is, the RO #2 of the first uplink BWP 245-a and the RO #0 of the second uplink BWP 245-b configured for a same type of RA procedure (e.g., Type-1 RA) may be mapped to a same location in the frequency domain, which correspond to a same accumulative RO index in the frequency domain.

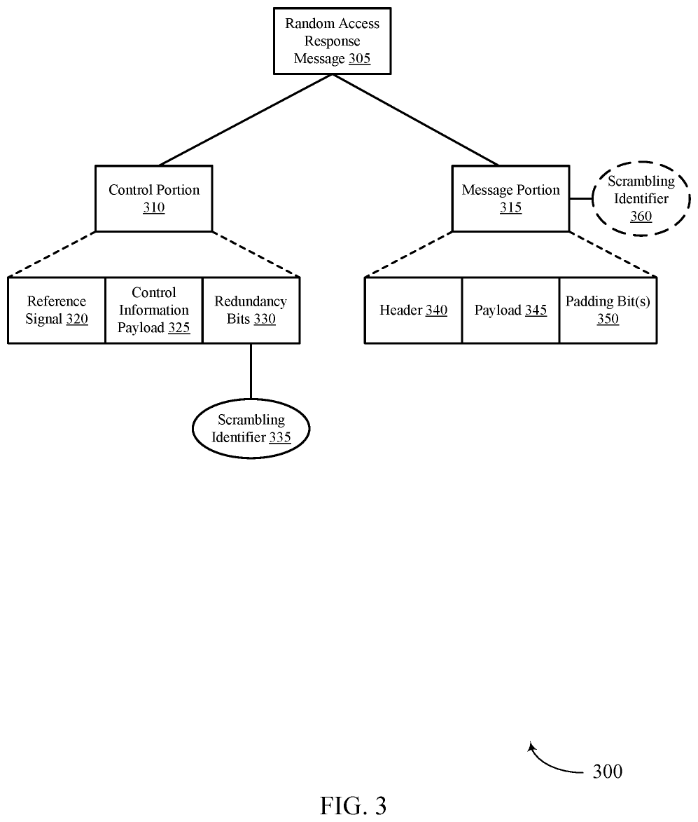

In some examples, the network entity 105 may additionally, or alternatively, include the sub-band index 230 and/or the FDM parameter 235 as part of the RAR message 225, which may be described in greater detail herein, including with reference to FIG. 3. Accordingly, the devices of the wireless communications system 200 may utilize techniques that improve reliability of RA procedures for virtual cells (e.g., a fragmented spectrum, non-contiguous sub-band allocations). For instance, the network entity 105 and one or more UEs 115 may resolve potential collisions associated with RA procedures (e.g., between multiple RA messages 220, multiple RAR messages 225) for devices that operate on partially overlapping BWPs within a same virtual cell based on communicating the sub-band index 230 and the FDM parameter 235. Thus, the wireless communications system 200 may support improved latency associate with RA procedures and improved coordination between devices, among other benefits.

FIG. 3 shows an example of a message structure 300 that supports RA procedures with a virtual cell in accordance with one or more aspects of the present disclosure. For example, the message structure 300 may show a structure of a RAR message 305, which may be an example of an RAR message 225 as described with reference to FIG. 2. In some examples, to resolve potential collisions (e.g., ambiguity) between various RAR messages 305 corresponding to RA messages associated with UEs 115 from different uplink BWPs (e.g., including different sub-bands) of a virtual cell, a network entity 105 may transmit a RAR message 305 to one or more UEs 115, which may include, in one or more portions, a sub-band index, l (e.g., a sub-band index 230) and/or one or more parameters (e.g., a sub-band specific RO index, n_{l,Q}, an FDM parameter 235).

In some examples, a collision (e.g., ambiguity) encountered by a UE 115 in decoding a RAR of a Type-Q RA procedure may be mitigated by enhancements to a control portion 310 of the RAR message 305 (e.g., a control channel portion, a PDCCH associated with the RAR message 305). For instance, the RAR message 305 for Type-Q RA procedure may be transmitted (e.g., by a network entity 105 to a UE 115) on a message portion 315 (e.g., a shared channel portion, a PDSCH) that is scheduled by the control portion 310 (e.g., the enhanced PDCCH). The message portion 315 may carry a MAC protocol data unit (PDU) that includes one or more MAC RARs or MAC subPDUs. The one or more MAC RARs or MAC subPDUs may target a group of UEs 115 that have selected a same RO (e.g., an RO 250) and transmitted PRACH preambles configured on the shared RO. The control portion 310 may be associated with scheduling the message portion 315 carrying RAR for Type-Q RA procedure, and a CRC of a payload of the control portion 310 (e.g., the PDCCH payload) may be scrambled by a group RNTI that is associated with the shared RO configured for Type-Q RA procedure (e.g., an RA-RNTI of Type-1 RA procedure may be associated with a msgB-RNTI of Type-2 RA procedure).

The control portion 310 may be enhanced to include (e.g., encode, map, indicate) information associated with a sub-band index and a sub-band specific RO index in one or more fields (e.g., entries, portions) of the control portion 310. In a first example, the sub-band index (e.g., l), and/or the sub-band specific RO index of the shared RO (e.g., n_{l,Q}) may be mapped to one or more fields (e.g., downlink control information (DCI) fields) of the control information payload 325 (e.g., a PDCCH payload). That is, the sub-band index and/or the sub-band specific RO index may be explicitly signaled via the control information payload 325. In a second example, the control portion 310 may include the sub-band index and/or the sub-band specific RO index in one or more redundancy bits 330 (e.g., CRC bits generation, CRC bits for the PDCCH payload). In a third example, the sub-band index and/or the sub-band specific RO index may be mapped (e.g., encoded in) a scrambling identifier 335 of a reference signal 320 of the control portion 310 (e.g., a scrambling identifier of a demodulation reference signal (DMRS) of the PDCCH). In a fourth example, the sub-band index and/or the sub-band specific RO index may be included (e.g., encoded) in a bit interleaving pattern of the control portion 310. In some examples, the sub-band index and/or the sub-band specific RO index may be mapped to (e.g., included in, encoded in) a combination of fields of the control portion 310 (e.g., including a hybrid combination of the example described herein).

Additionally, or alternatively, the message portion 315 may be enhanced to include (e.g., encode, map, indicate) information associated with a sub-band index and a sub-band specific RO index in one or more fields (e.g., entries, portions) of the message portion 315, which may mitigate collisions and ambiguity in RA procedures. For example, an RAR message 305 for a type-Q RA procedure may be transmitted via a PDSCH, which may carry (e.g., include, communicate) a message portion 315 (e.g., a MAC PDU). The message portion 315 may include that includes a header 340 (e.g., a MAC sub-header, a MAC sub-PDU header), a payload 345 (e.g., one or more MAC RAR messages, a MAC sub-PDU), and one or more padding bits 350 (e.g., MAC PDU padding bits). In some examples, the message portion 315 may also be associated with a scrambling identifier 360.

The information associated with a sub-band index and a sub-band specific RO index in may be included in the message portion 315 in accordance with various examples. In a first example, the sub-band index (e.g., l), and/or the sub-band specific RO index of the shared RO (e.g., n_{l,Q}) may be mapped to the header 340 (e.g., the MAC sub-header). In a second example, the sub-band index and/or the sub-band specific RO index of the shared RO may be mapped to the payload 345 (e.g., a payload of a MAC sub-PDU). In a third example, the sub-band index and/or the sub-band specific RO index of the shared RO may be mapped to the one or more padding bits 350 (e.g., padding bits of the MAC PDU). In a fourth example, the sub-band index and/or the sub-band specific RO index of the shared RO may be mapped to the scrambling identifier 360 (e.g., a scrambling identifier of a DMRS associated with the PDSCH). In some examples, the sub-band index and/or the sub-band specific RO index may be mapped to (e.g., included in, encoded in) a combination of fields of the message portion 315 (e.g., including a hybrid combination of the example described herein).

In another example, the sub-band index and/or the sub-band specific RO index may be mapped to a combination of fields across both of the control portion 310 and the message portion 315 (e.g., a joint PDDCH and RAR enhancement) in accordance with one or more examples described herein. For example, one or more fields of the control portion 310 may be used to indicate at least a first portion (e.g., three most significant bits) of the sub-band index and/or the sub-band specific RO index and one or more fields of the message portion 315 may be used to indicate at least a second portion (e.g., two least significant bits) of the sub-band index and/or the sub-band specific RO index (e.g., based on a payload size constraint, based on a bit width constraint).

Thus, by enhancing the control portion 310, the message portion 315, or both to include the sub-band index and/or the sub-band specific RO index (e.g., l, n_{l,Q}), a RAR message 305 may be uniquely coded such that a target UE 115 may successfully receive (e.g., decode) the RAR message 305 while other UEs 115 may fail to receive (e.g., decode) the RAR message 305. Accordingly, collisions between different RAR messages 305 for different UEs 115 operating on different sub-bands of a virtual cell may be mitigated thus increasing reliability of communications and improved device coordination in wireless communications systems.

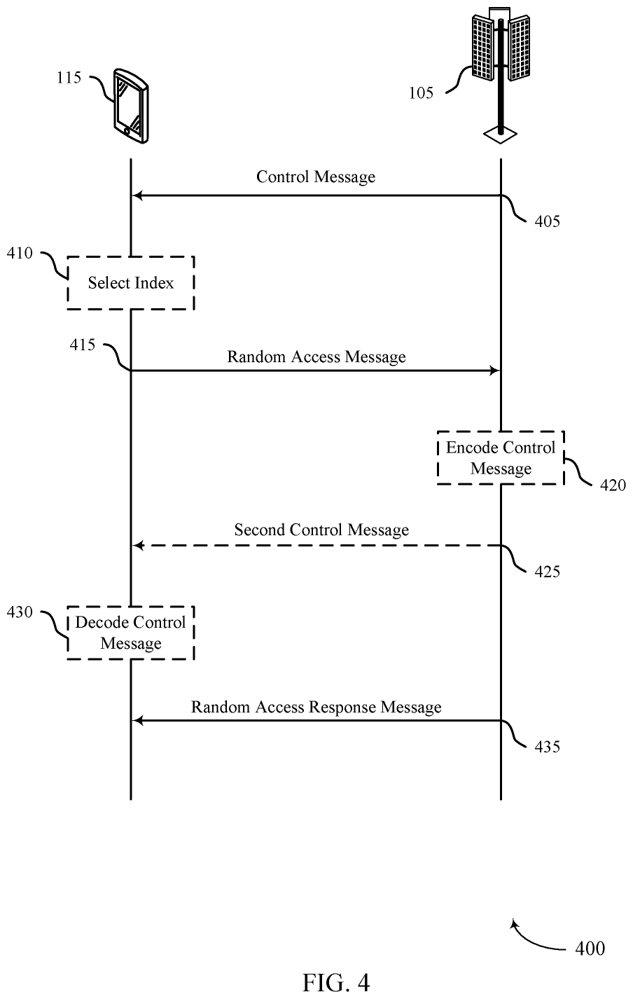

FIG. 4 shows an example of a process flow 400 that supports RA procedures with a virtual cell in accordance with one or more aspects of the present disclosure. In some examples, process flow 400 may implement aspects of the wireless communications system 100, the wireless communications system 200, and the message structure 300. For example, the process flow 400 may support signaling between a UE 115 and a network entity 105 (e.g., a virtual cell) to mitigate collisions and ambiguities in RA procedures on a virtual cell. The UE 115 and the network entity 105 of the process flow 400 may be examples of corresponding devices herein, including with reference to FIGS. 1 and 2.

In the following description of process flow 400, the operations between the UE 115 and the network entity 105 may be performed in a different order than the order shown, or other operations may be added or removed from the process flow 400. For example, some operations may also be left out of process flow 400, or may be performed in different orders or at different times. Further, although some operations or signaling may be shown to occur at different times for discussion purposes, these operations may actually occur at the same time. Although the UE 115 and the network entity 105 are shown performing the operations of process flow 400, some aspects of some operations may also be performed by one or more other wireless or network devices.

At 405, the UE 115 may receive a control message (e.g., a control message 215, an SI message, an RRC message) that includes an index of a sub-band (e.g., l) of a set of multiple of sub-bands of a virtual cell and a quantity of RA occasions (e.g., ROs, No) associated with the sub-band, which may be output (e.g., transmitted) by the network entity 105. In some examples, the quantity of RA occasions may be based on a type of RA procedure (e.g., a type 1 RA procedure, a type 2 RA procedure). In some examples, at least a first sub-band of the set of multiple of sub-bands and a second sub-band of the set of multiple of sub-bands may be non-contiguous in a frequency domain.

At 410, the UE may, in some examples, select (e.g., derive, calculate, determine, identify) a first index (e.g., F_{id,Q}, an accumulative RO index, a PRACH resource) based on combining the quantity of RA occasions with one or more second quantities of RA occasions associated with one or more second sub-bands (e.g., from other sub-bands, Σₖ₌₀^{l-1}N_{Q}^{l}). In some examples, the UE may select a second index (e.g., n_{l,Q}) of an RA occasion based on the index of the sub-band and the quantity of RA occasions. In such examples, the first index may be based on combining the second index with the combined quantity of RA occasions (e.g., F_{id,Q}=n_{l,Q}+Σₖ₌₀^{l-1}N_{Q}^{k} for all sub-bands, k). The second index may be a sub-band specific index and the first index may be a non-sub-band specific index (e.g., an accumulative RO index, an absolute RO index).

At 415, the UE 115 may transmit an RA message (e.g., an RA message 220, a PRACH for Type 1 or Type 2 RA procedure) within an RA occasion of the quantity of RA occasions indicated by the control message, which may be obtained (e.g., received) by a network entity 105. In some examples, the UE 115 may transmit the RA message in accordance with the index selections of 410 (e.g., based on F_{id,Q}). In some examples, the UE 115 may transmit the RA message in accordance with a temporary identifier, and the temporary identifier may be associated with a first type of RA procedure and the first index (e.g., a group RNTI calculated based on F_{id,Q}). In some examples, a temporary identifier for a first type of RA may be different than one or more second temporary identifiers associated with a second type of RA procedure based on the first index (e.g., range of group RNTI values for different types of RA procedure may not overlap based on the accumulative RO index).

At 420, the network entity 105 may, in some examples, encode a second control message (e.g., a control portion 310 of a RAR message 305) in accordance with the index of the sub-band (e.g., l), the RA occasion (e.g., n_{l,Q}), or both based on one or more fields of the second control message (e.g., a control information payload 325), one or more CRC bits of the second control message (e.g., redundancy bits 330), a reference signal scrambling identifier of the second control message (e.g., a scrambling identifier 335 of a reference signal 320), a bit interleaving pattern of the second control message, some other field of the second control message, or any combination thereof.

At 425, the UE 115 may, in some examples, receive the second control message, which may be associated with an RAR message, which may be output by the network entity 105. The UE 115 may receive the RAR message based on transmitting the RA message. In some examples, the RAR message may be associated with the index of the sub-band, the RA occasion, or both based on the UE 115 receiving the second control message. In some examples, the second control message may include one or more fields that indicate the index of the sub-band, the RA occasion, or both.

At 430, the UE 115 may, in some examples, decode the second control message in accordance with the index of the sub-band, the RA occasion, or both. For example, the UE 115 may decode the second control message based on one or more CRC bits of the second control message, a reference signal scrambling identifier of the second control message, a bit interleaving pattern of the second control message, or any combination thereof. In some examples, the UE 115 may receive an RAR message based on decoding the second control message.

At 435, the UE 115 may receive an RAR message (e.g., an RAR message 225, an RAR message 305) that is associated with the index of the sub-band, the RA occasion, or both, which may be output by the network entity 105. The UE 115 may receive the RAR message after (e.g., based on, in response to) transmitting the RA message. In some examples, the UE 115 may receive, via the RAR message, an indication of the index of the sub-band, an indication of the RA occasion, or both. In some examples, the UE may receive the indication of the index of the sub-band, the indication of the RA occasion of the RAR message, or both via a MAC header of the RAR message, a MAC payload (e.g., of the RAR message), one or more padding bits of the RAR message, a reference signal scrambling identifier of the RAR message, or a combination thereof. In some examples, the UE 115 may receive the RAR message in accordance with the index of the sub-band, the RA occasion, or both based on first information (e.g., a first portion of the index of the sub-band and/or the indication of the RA occasion of the RAR message) included in a second control message associated with the RAR message and second information (e.g., a second portion of the index of the sub-band and/or the indication of the RA occasion of the RAR message) included in the RAR message.

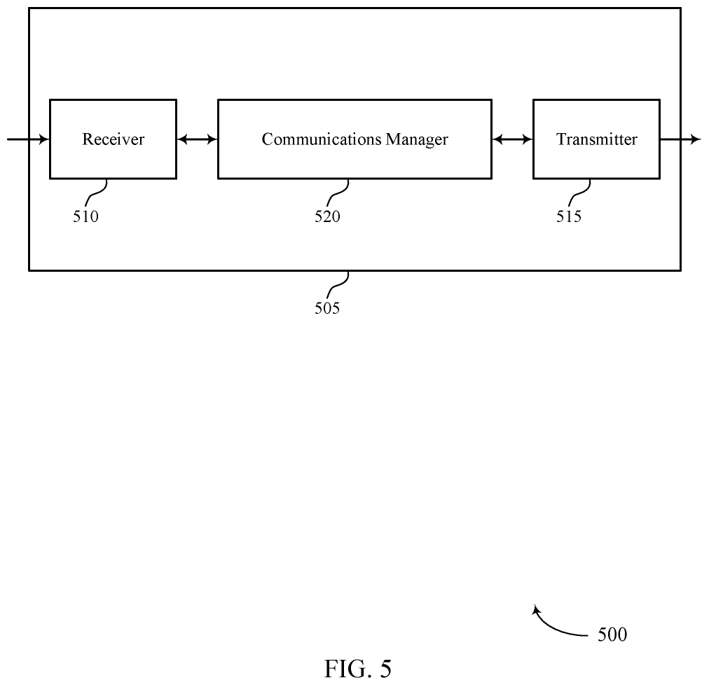

FIG. 5 shows a block diagram 500 of a device 505 that supports RA procedures with a virtual cell in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to random access procedures with a virtual cell). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to random access procedures with a virtual cell). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of random access procedures with a virtual cell as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a control message that includes an index of a sub-band of a set of multiple sub-bands of a virtual cell and a quantity of random access occasions associated with the sub-band. The communications manager 520 is capable of, configured to, or operable to support a means for transmitting a random access message within a random access occasion of the quantity of random access occasions indicated by the control message. The communications manager 520 is capable of, configured to, or operable to support a means for receiving a random access response message that is associated with the index of the sub-band, the random access occasion, or both after transmitting the random access message.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources, among other benefits.

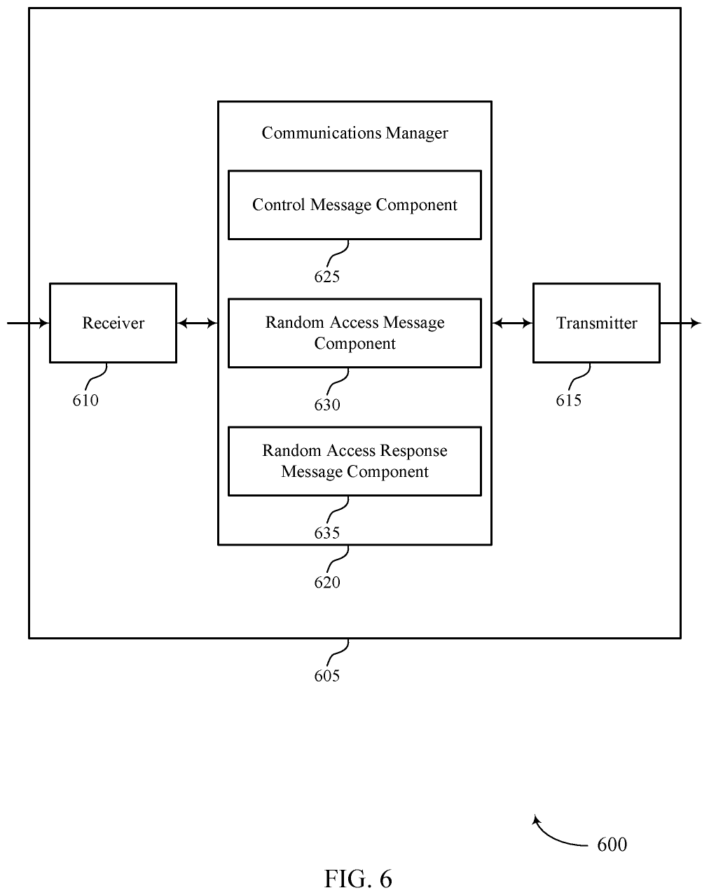

FIG. 6 shows a block diagram 600 of a device 605 that supports random access procedures with a virtual cell in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to random access procedures with a virtual cell). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to random access procedures with a virtual cell). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of random access procedures with a virtual cell as described herein. For example, the communications manager 620 may include a control message component 625, a random access message component 630, a random access response message component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The control message component 625 is capable of, configured to, or operable to support a means for receiving a control message that includes an index of a sub-band of a set of multiple sub-bands of a virtual cell and a quantity of random access occasions associated with the sub-band. The random access message component 630 is capable of, configured to, or operable to support a means for transmitting a random access message within a random access occasion of the quantity of random access occasions indicated by the control message. The random access response message component 635 is capable of, configured to, or operable to support a means for receiving a random access response message that is associated with the index of the sub-band, the random access occasion, or both after transmitting the random access message.

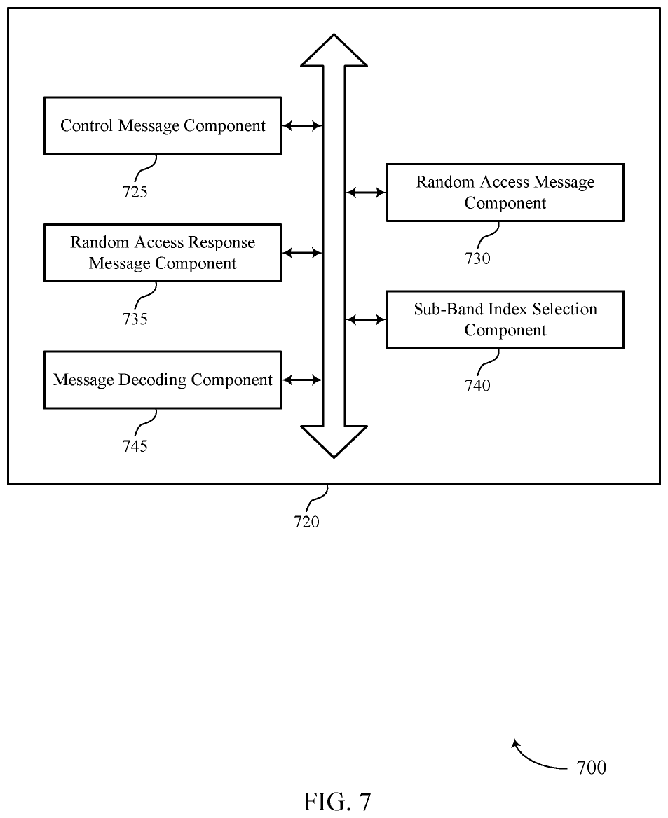

FIG. 7 shows a block diagram 700 of a communications manager 720 that supports random access procedures with a virtual cell in accordance with one or more aspects of the present disclosure. The communications manager 720 may be an example of aspects of a communications manager 520, a communications manager 620, or both, as described herein. The communications manager 720, or various components thereof, may be an example of means for performing various aspects of random access procedures with a virtual cell as described herein. For example, the communications manager 720 may include a control message component 725, a random access message component 730, a random access response message component 735, a sub-band index selection component 740, a message decoding component 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The control message component 725 is capable of, configured to, or operable to support a means for receiving a control message that includes an index of a sub-band of a set of multiple sub-bands of a virtual cell and a quantity of random access occasions associated with the sub-band. The random access message component 730 is capable of, configured to, or operable to support a means for transmitting a random access message within a random access occasion of the quantity of random access occasions indicated by the control message. The random access response message component 735 is capable of, configured to, or operable to support a means for receiving a random access response message that is associated with the index of the sub-band, the random access occasion, or both after transmitting the random access message.

In some examples, to support transmitting the random access message, the random access response message component 735 is capable of, configured to, or operable to support a means for transmitting the random access message in accordance with a first index, where the first index is based on combining the quantity of random access occasions with one or more second quantities of random access occasions associated with one or more second sub-bands.

In some examples, the sub-band index selection component 740 is capable of, configured to, or operable to support a means for selecting a second index of the random access occasion based on the index of the sub-band and the quantity of random access occasions, where the first index is based on combining the second index with the combined quantity of random access occasions, and where the second index is a sub-band specific index and the first index is a non-sub-band specific index.

In some examples, the random access message component 730 is capable of, configured to, or operable to support a means for transmitting the random access message in accordance with a temporary identifier, the temporary identifier being associated with a first type of random access procedure and the first index, where the temporary identifier is different than one or more second temporary identifiers associated with a second type of random access procedure based on the first index.

In some examples, to support receiving the random access response message, the control message component 725 is capable of, configured to, or operable to support a means for receiving a second control message associated with the random access response message based on transmitting the random access message, where the random access response message is associated with the index of the sub-band, the random access occasion, or both based on receiving the second control message.

In some examples, the second control message includes one or more fields that indicate the index of the sub-band, the random access occasion, or both.

In some examples, the message decoding component 745 is capable of, configured to, or operable to support a means for decoding the second control message in accordance with the index of the sub-band, the random access occasion, or both based on one or more cyclic redundancy check bits of the second control message, a reference signal scrambling identifier of the second control message, a bit interleaving pattern of the second control message, or any combination thereof, where receiving the random access response message is based on decoding the second control message.

In some examples, to support receiving the random access response message, the random access response message component 735 is capable of, configured to, or operable to support a means for receiving, via the random access response message, an indication of the index of the sub-band, an indication of the random access occasion, or both.

In some examples, to support receiving the indication, the random access response message component 735 is capable of, configured to, or operable to support a means for receiving the indication of the index of the sub-band, the indication of the random access occasion of the random access response message, or both via a MAC header of the random access response message, a MAC payload, one or more padding bits of the random access response message, a reference signal scrambling identifier of the random access response message, or a combination thereof.

In some examples, to support receiving the random access response message, the random access response message component 735 is capable of, configured to, or operable to support a means for receiving the random access response message in accordance with the index of the sub-band, the random access occasion, or both based on first information included in a second control message associated with the random access response message and second information included in the random access response message.

In some examples, the quantity of random access occasions is based on a type of random access procedure.

In some examples, at least a first sub-band of the set of multiple sub-bands and a second sub-band of the set of multiple sub-bands are non-contiguous in a frequency domain.

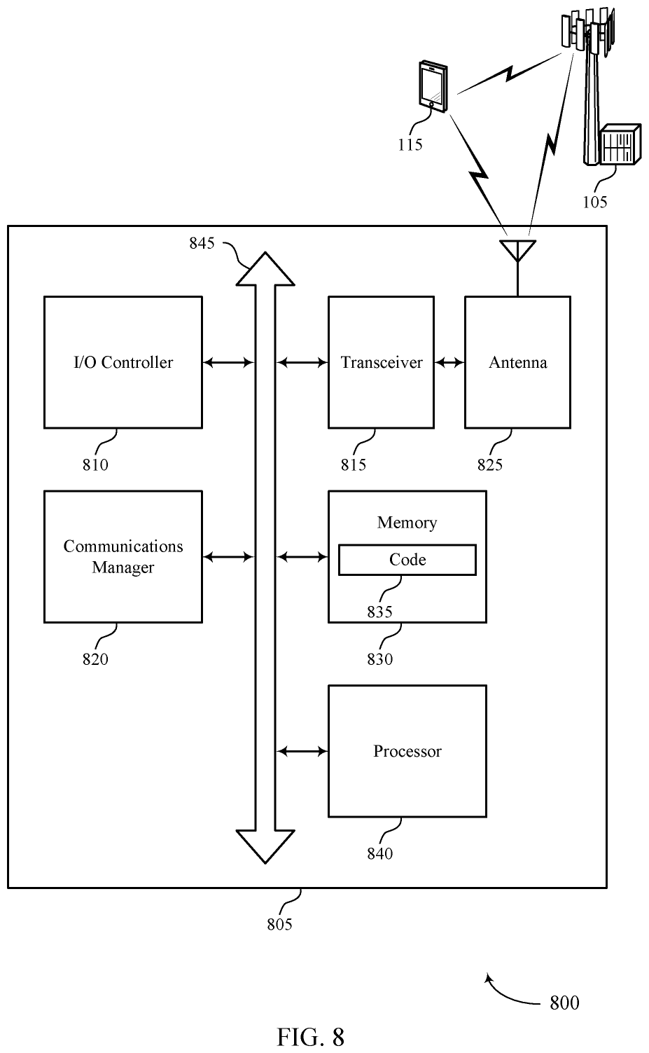

FIG. 8 shows a diagram of a system 800 including a device 805 that supports random access procedures with a virtual cell in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting random access procedures with a virtual cell). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a control message that includes an index of a sub-band of a set of multiple sub-bands of a virtual cell and a quantity of random access occasions associated with the sub-band. The communications manager 820 is capable of, configured to, or operable to support a means for transmitting a random access message within a random access occasion of the quantity of random access occasions indicated by the control message. The communications manager 820 is capable of, configured to, or operable to support a means for receiving a random access response message that is associated with the index of the sub-band, the random access occasion, or both after transmitting the random access message.

By including or configuring the communications manager 820 in accordance with examples as described herein, the device 805 may support techniques for improved communication reliability, reduced latency (e.g., associated with RA procedures), and improved coordination between devices, among other benefits.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of random access procedures with a virtual cell as described herein, or the at least one processor 840 and the at least one memory 830 may be otherwise configured to, individually or collectively, perform or support such operations.

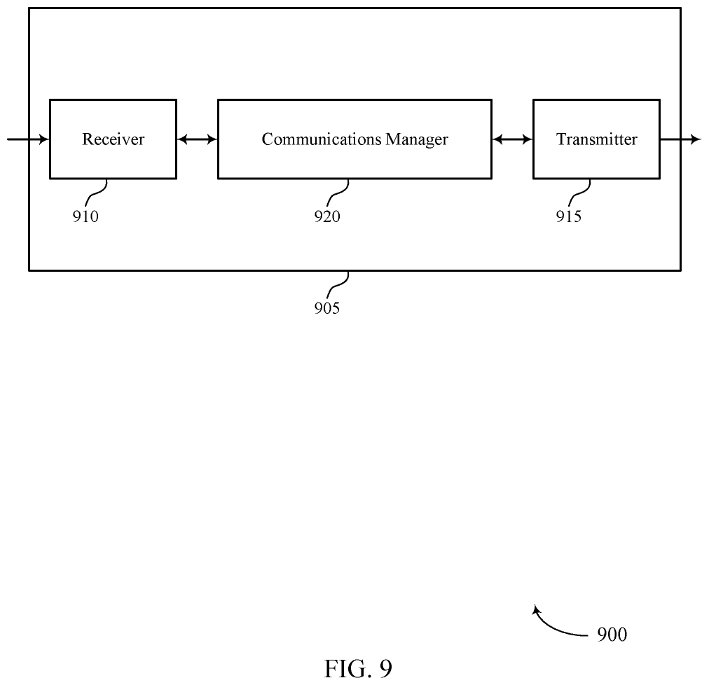

FIG. 9 shows a block diagram 900 of a device 905 that supports random access procedures with a virtual cell in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of random access procedures with a virtual cell as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting a control message that includes an index of a sub-band of a set of multiple sub-bands of a virtual cell and a quantity of random access occasions associated with the sub-band. The communications manager 920 is capable of, configured to, or operable to support a means for obtaining a random access message within a random access occasion of the quantity of random access occasions indicated by the control message. The communications manager 920 is capable of, configured to, or operable to support a means for outputting, to a UE, a random access response message that is associated with the index of the sub-band, the random access occasion, or both after obtaining the random access message.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources, among other benefits.

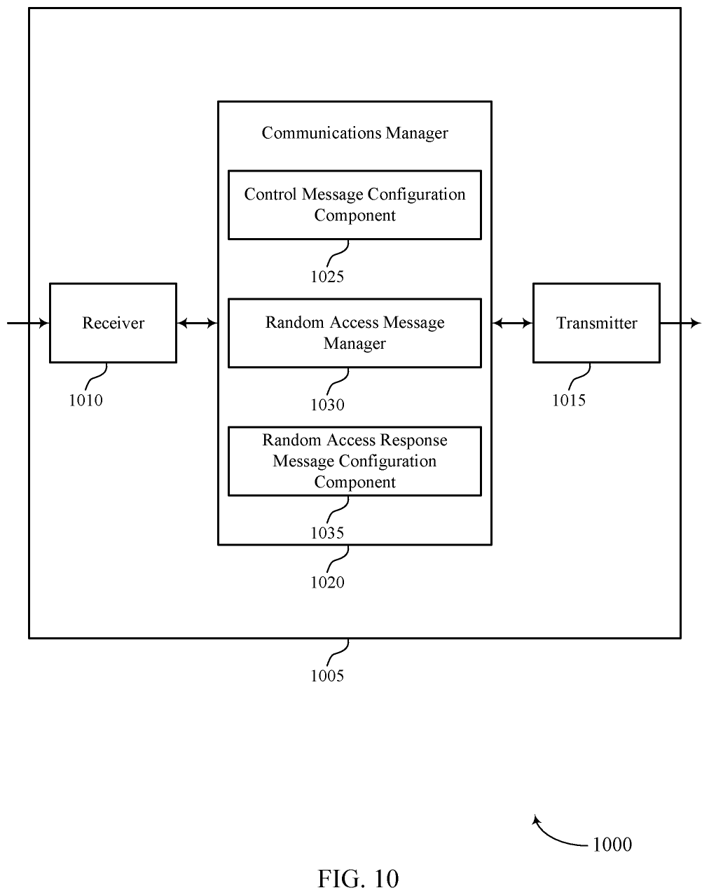

FIG. 10 shows a block diagram 1000 of a device 1005 that supports random access procedures with a virtual cell in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of random access procedures with a virtual cell as described herein. For example, the communications manager 1020 may include a control message configuration component 1025, a random access message manager 1030, a random access response message configuration component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The control message configuration component 1025 is capable of, configured to, or operable to support a means for outputting a control message that includes an index of a sub-band of a set of multiple sub-bands of a virtual cell and a quantity of random access occasions associated with the sub-band. The random access message manager 1030 is capable of, configured to, or operable to support a means for obtaining a random access message within a random access occasion of the quantity of random access occasions indicated by the control message. The random access response message configuration component 1035 is capable of, configured to, or operable to support a means for outputting, to a UE, a random access response message that is associated with the index of the sub-band, the random access occasion, or both after obtaining the random access message.

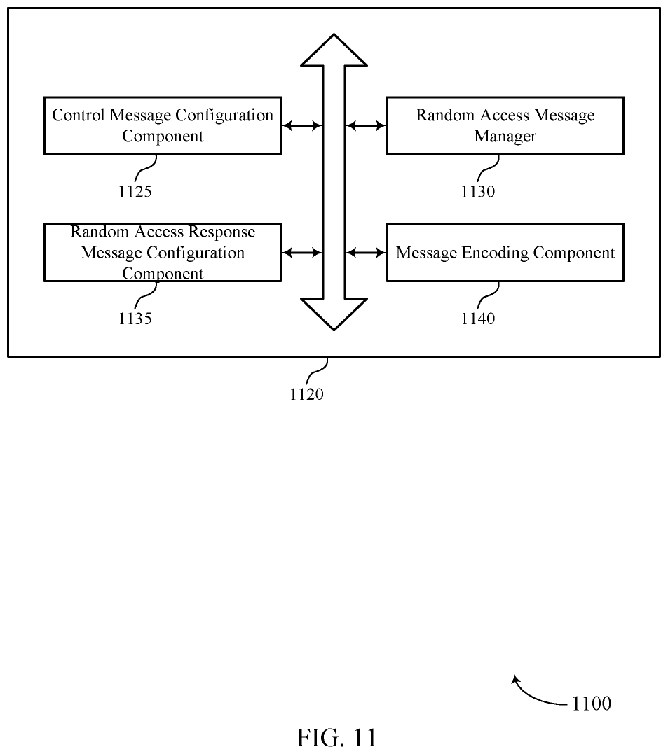

FIG. 11 shows a block diagram 1100 of a communications manager 1120 that supports random access procedures with a virtual cell in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of random access procedures with a virtual cell as described herein. For example, the communications manager 1120 may include a control message configuration component 1125, a random access message manager 1130, a random access response message configuration component 1135, a message encoding component 1140, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The control message configuration component 1125 is capable of, configured to, or operable to support a means for outputting a control message that includes an index of a sub-band of a set of multiple sub-bands of a virtual cell and a quantity of random access occasions associated with the sub-band. The random access message manager 1130 is capable of, configured to, or operable to support a means for obtaining a random access message within a random access occasion of the quantity of random access occasions indicated by the control message. The random access response message configuration component 1135 is capable of, configured to, or operable to support a means for outputting, to a UE, a random access response message that is associated with the index of the sub-band, the random access occasion, or both after obtaining the random access message.

In some examples, to support obtaining the random access message, the random access message manager 1130 is capable of, configured to, or operable to support a means for obtaining the random access message in accordance with a first index, where the first index is based on a combination of the quantity of random access occasions with one or more second quantities of random access occasions associated with one or more second sub-bands.

In some examples, the first index is based on a combination of a second index of the random access occasion and the combined quantity of random access occasions, the second index based on the index of the sub-band and the quantity of random access occasions. In some examples, the second index is a sub-band specific index and the first index is a non-sub-band specific index.

In some examples, the random access message manager 1130 is capable of, configured to, or operable to support a means for obtaining the random access message in accordance with a temporary identifier, the temporary identifier being associated with a first type of random access procedure and the first index, where the temporary identifier is different than one or more second temporary identifiers associated with a second type of random access procedure based on the first index.

In some examples, to support outputting the random access response message, the control message configuration component 1125 is capable of, configured to, or operable to support a means for outputting a second control message associated with the random access response message based on obtaining the random access message, where the random access response message is associated with the index of the sub-band, the random access occasion, or both based on outputting the second control message.

In some examples, the second control message includes one or more fields that indicate the index of the sub-band, the random access occasion, or both.

In some examples, the message encoding component 1140 is capable of, configured to, or operable to support a means for encoding the second control message in accordance with the index of the sub-band, the random access occasion, or both based on one or more cyclic redundancy check bits of the second control message, a reference signal scrambling identifier of the second control message, a bit interleaving pattern of the second control message, or any combination thereof.

In some examples, to support outputting the random access response message, the random access response message configuration component 1135 is capable of, configured to, or operable to support a means for outputting, via the random access response message, an indication of the index of the sub-band, an indication of the random access occasion, or both.

In some examples, to support outputting the indication, the random access response message configuration component 1135 is capable of, configured to, or operable to support a means for outputting the indication of the index of the sub-band, the indication of the random access occasion of the random access response message, or both via a MAC header of the random access response message, a MAC payload, one or more padding bits of the random access response message, a reference signal scrambling identifier of the random access response message, or a combination thereof.

In some examples, to support outputting the random access response message, the random access response message configuration component 1135 is capable of, configured to, or operable to support a means for outputting the random access response message in accordance with the index of the sub-band, the random access occasion, or both based on including first information in a second control message associated with the random access response message and second information in the random access response message.

In some examples, the quantity of random access occasions is based on a type of random access procedure.

In some examples, at least a first sub-band of the set of multiple sub-bands and a second sub-band of the set of multiple sub-bands are non-contiguous in a frequency domain.

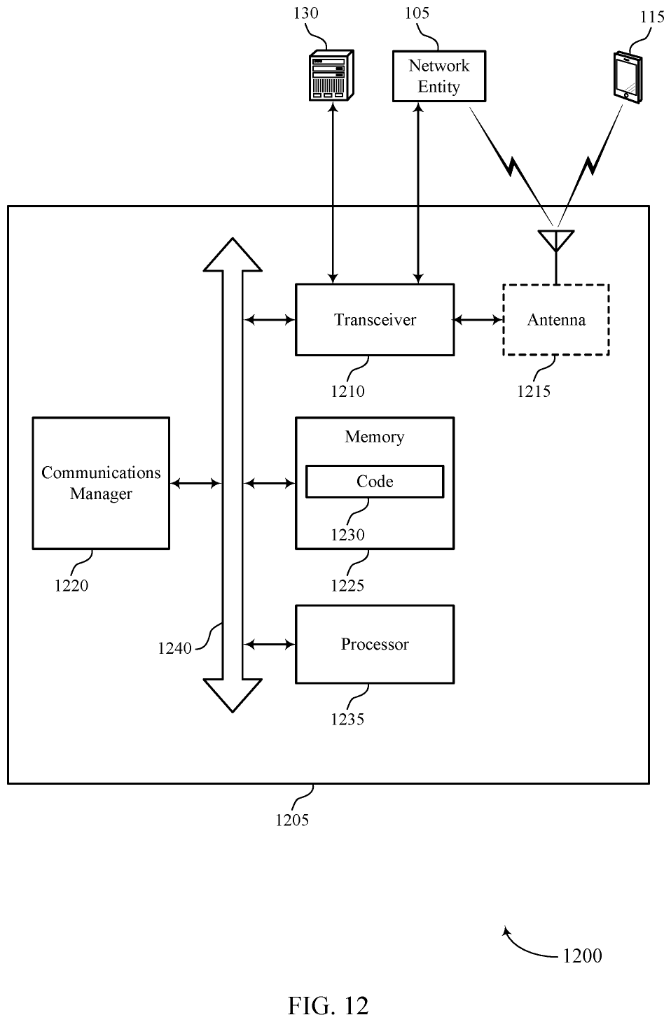

FIG. 12 shows a diagram of a system 1200 including a device 1205 that supports random access procedures with a virtual cell in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting random access procedures with a virtual cell). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting a control message that includes an index of a sub-band of a set of multiple sub-bands of a virtual cell and a quantity of random access occasions associated with the sub-band. The communications manager 1220 is capable of, configured to, or operable to support a means for obtaining a random access message within a random access occasion of the quantity of random access occasions indicated by the control message. The communications manager 1220 is capable of, configured to, or operable to support a means for outputting, to a UE, a random access response message that is associated with the index of the sub-band, the random access occasion, or both after obtaining the random access message.

By including or configuring the communications manager 1220 in accordance with examples as described herein, the device 1205 may support techniques for improved communication reliability, reduced latency, and improved coordination between devices, among other benefits.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of random access procedures with a virtual cell as described herein, or the at least one processor 1235 and the at least one memory 1225 may be otherwise configured to, individually or collectively, perform or support such operations.

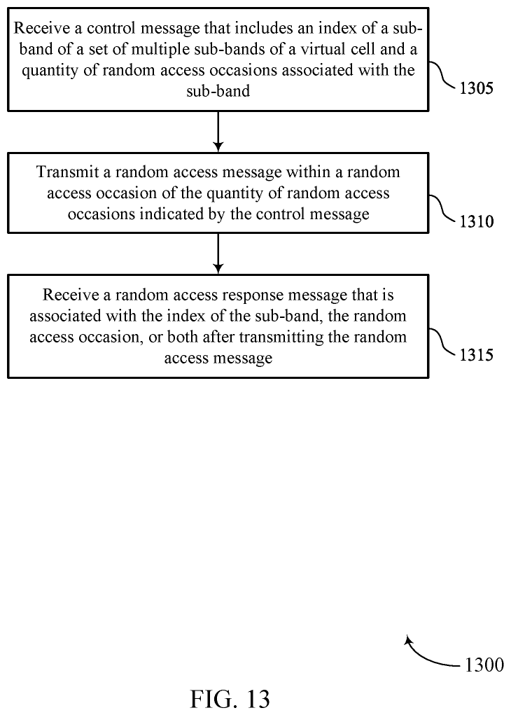

FIG. 13 shows a flowchart illustrating a method 1300 that supports random access procedures with a virtual cell in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a control message that includes an index of a sub-band of a set of multiple sub-bands of a virtual cell and a quantity of random access occasions associated with the sub-band. The operations of block 1305 may be performed in accordance with examples as disclosed herein. In some examples, aspects of the operations of 1305 may be performed by a control message component 725 as described with reference to FIG. 7.

At 1310, the method may include transmitting a random access message within a random access occasion of the quantity of random access occasions indicated by the control message. The operations of block 1310 may be performed in accordance with examples as disclosed herein. In some examples, aspects of the operations of 1310 may be performed by a random access message component 730 as described with reference to FIG. 7.

At 1315, the method may include receiving a random access response message that is associated with the index of the sub-band, the random access occasion, or both after transmitting the random access message. The operations of block 1315 may be performed in accordance with examples as disclosed herein. In some examples, aspects of the operations of 1315 may be performed by a random access response message component 735 as described with reference to FIG. 7.

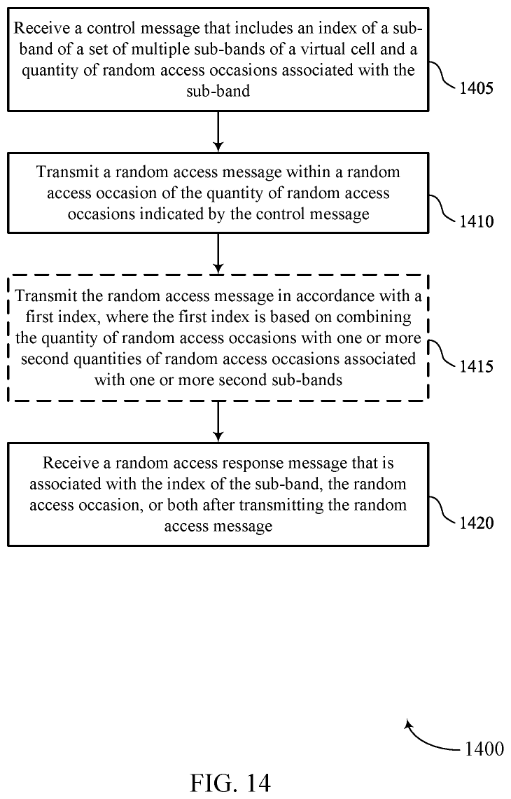

FIG. 14 shows a flowchart illustrating a method 1400 that supports random access procedures with a virtual cell in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a control message that includes an index of a sub-band of a set of multiple sub-bands of a virtual cell and a quantity of random access occasions associated with the sub-band. The operations of block 1405 may be performed in accordance with examples as disclosed herein. In some examples, aspects of the operations of 1405 may be performed by a control message component 725 as described with reference to FIG. 7.

At 1410, the method may include transmitting a random access message within a random access occasion of the quantity of random access occasions indicated by the control message. The operations of block 1410 may be performed in accordance with examples as disclosed herein. In some examples, aspects of the operations of 1410 may be performed by a random access message component 730 as described with reference to FIG. 7.

At 1415, the method may include transmitting the random access message in accordance with a first index, where the first index is based on combining the quantity of random access occasions with one or more second quantities of random access occasions associated with one or more second sub-bands. The operations of block 1415 may be performed in accordance with examples as disclosed herein. In some examples, aspects of the operations of 1415 may be performed by a random access response message component 735 as described with reference to FIG. 7.

At 1420, the method may include receiving a random access response message that is associated with the index of the sub-band, the random access occasion, or both after transmitting the random access message. The operations of block 1420 may be performed in accordance with examples as disclosed herein. In some examples, aspects of the operations of 1420 may be performed by a random access response message component 735 as described with reference to FIG. 7.

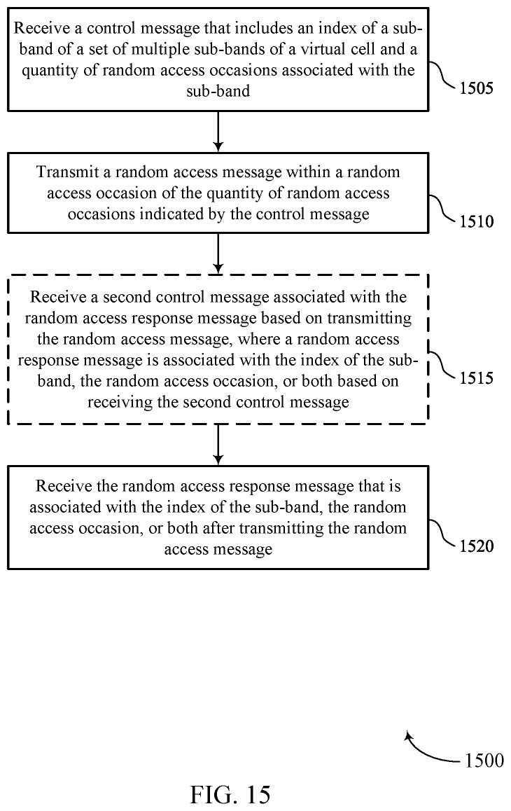

FIG. 15 shows a flowchart illustrating a method 1500 that supports random access procedures with a virtual cell in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving a control message that includes an index of a sub-band of a set of multiple sub-bands of a virtual cell and a quantity of random access occasions associated with the sub-band. The operations of block 1505 may be performed in accordance with examples as disclosed herein. In some examples, aspects of the operations of 1505 may be performed by a control message component 725 as described with reference to FIG. 7.

At 1510, the method may include transmitting a random access message within a random access occasion of the quantity of random access occasions indicated by the control message. The operations of block 1510 may be performed in accordance with examples as disclosed herein. In some examples, aspects of the operations of 1510 may be performed by a random access message component 730 as described with reference to FIG. 7.

At 1515, the method may include receiving a second control message associated with the random access response message based on transmitting the random access message, where a random access response message is associated with the index of the sub-band, the random access occasion, or both based on receiving the second control message. The operations of block 1515 may be performed in accordance with examples as disclosed herein. In some examples, aspects of the operations of 1515 may be performed by a control message component 725 as described with reference to FIG. 7.

At 1520, the method may include receiving the random access response message that is associated with the index of the sub-band, the random access occasion, or both after transmitting the random access message. The operations of block 1520 may be performed in accordance with examples as disclosed herein. In some examples, aspects of the operations of 1520 may be performed by a random access response message component 735 as described with reference to FIG. 7.

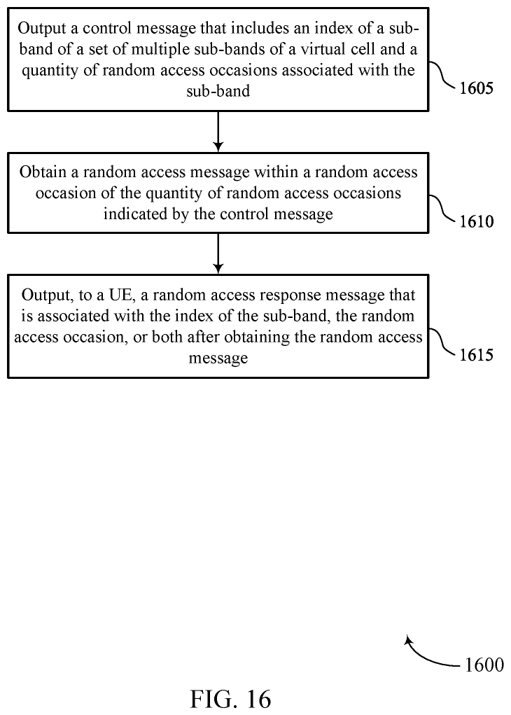

FIG. 16 shows a flowchart illustrating a method 1600 that supports random access procedures with a virtual cell in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting a control message that includes an index of a sub-band of a set of multiple sub-bands of a virtual cell and a quantity of random access occasions associated with the sub-band. The operations of block 1605 may be performed in accordance with examples as disclosed herein. In some examples, aspects of the operations of 1605 may be performed by a control message configuration component 1125 as described with reference to FIG. 11.

At 1610, the method may include obtaining a random access message within a random access occasion of the quantity of random access occasions indicated by the control message. The operations of block 1610 may be performed in accordance with examples as disclosed herein. In some examples, aspects of the operations of 1610 may be performed by a random access message manager 1130 as described with reference to FIG. 11.

At 1615, the method may include outputting, to a UE, a random access response message that is associated with the index of the sub-band, the random access occasion, or both after obtaining the random access message. The operations of block 1615 may be performed in accordance with examples as disclosed herein. In some examples, aspects of the operations of 1615 may be performed by a random access response message configuration component 1135 as described with reference to FIG. 11.

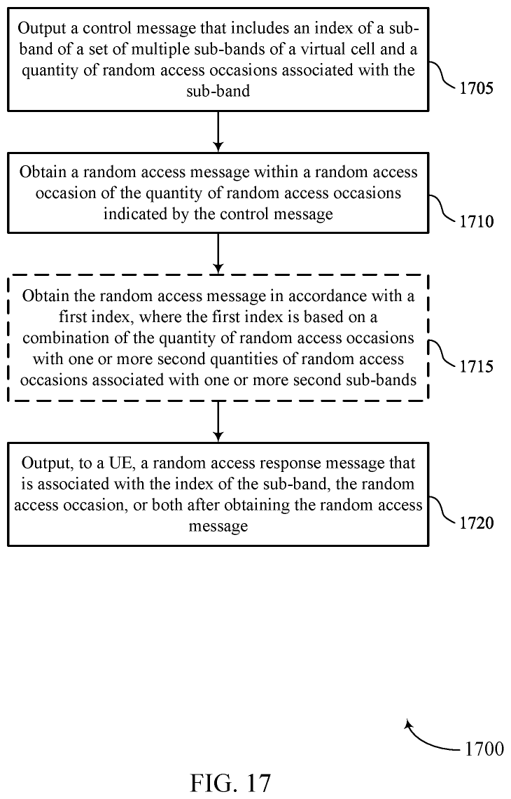

FIG. 17 shows a flowchart illustrating a method 1700 that supports random access procedures with a virtual cell in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include outputting a control message that includes an index of a sub-band of a set of multiple sub-bands of a virtual cell and a quantity of random access occasions associated with the sub-band. The operations of block 1705 may be performed in accordance with examples as disclosed herein. In some examples, aspects of the operations of 1705 may be performed by a control message configuration component 1125 as described with reference to FIG. 11.

At 1710, the method may include obtaining a random access message within a random access occasion of the quantity of random access occasions indicated by the control message. The operations of block 1710 may be performed in accordance with examples as disclosed herein. In some examples, aspects of the operations of 1710 may be performed by a random access message manager 1130 as described with reference to FIG. 11.

At 1715, the method may include obtaining the random access message in accordance with a first index, where the first index is based on a combination of the quantity of random access occasions with one or more second quantities of random access occasions associated with one or more second sub-bands. The operations of block 1715 may be performed in accordance with examples as disclosed herein. In some examples, aspects of the operations of 1715 may be performed by a random access message manager 1130 as described with reference to FIG. 11.

At 1720, the method may include outputting, to a UE, a random access response message that is associated with the index of the sub-band, the random access occasion, or both after obtaining the random access message. The operations of block 1720 may be performed in accordance with examples as disclosed herein. In some examples, aspects of the operations of 1720 may be performed by a random access response message configuration component 1135 as described with reference to FIG. 11.

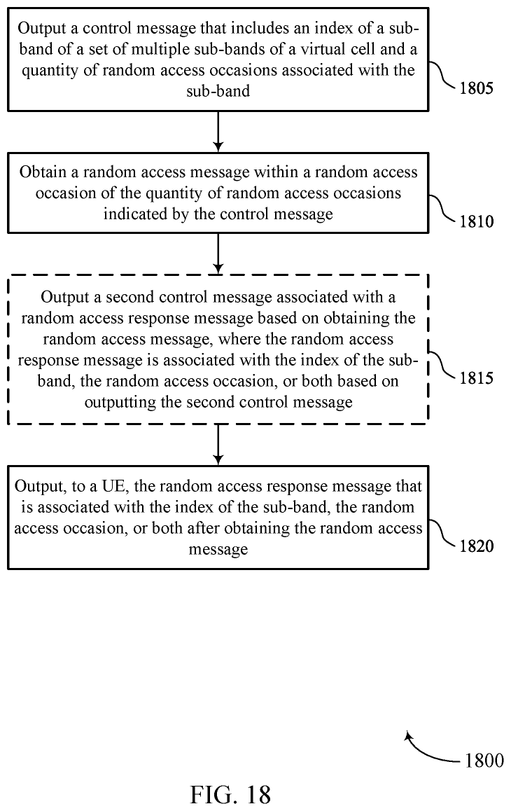

FIG. 18 shows a flowchart illustrating a method 1800 that supports random access procedures with a virtual cell in accordance with one or more aspects of the present disclosure. The operations of the method 1800 may be implemented by a network entity or its components as described herein. For example, the operations of the method 1800 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1805, the method may include outputting a control message that includes an index of a sub-band of a set of multiple sub-bands of a virtual cell and a quantity of random access occasions associated with the sub-band. The operations of block 1805 may be performed in accordance with examples as disclosed herein. In some examples, aspects of the operations of 1805 may be performed by a control message configuration component 1125 as described with reference to FIG. 11.

At 1810, the method may include obtaining a random access message within a random access occasion of the quantity of random access occasions indicated by the control message. The operations of block 1810 may be performed in accordance with examples as disclosed herein. In some examples, aspects of the operations of 1810 may be performed by a random access message manager 1130 as described with reference to FIG. 11.

At 1815, the method may include outputting a second control message associated with a random access response message based on obtaining the random access message, where the random access response message is associated with the index of the sub-band, the random access occasion, or both based on outputting the second control message. The operations of block 1815 may be performed in accordance with examples as disclosed herein. In some examples, aspects of the operations of 1815 may be performed by a control message configuration component 1125 as described with reference to FIG. 11.

At 1820, the method may include outputting, to a UE, the random access response message that is associated with the index of the sub-band, the random access occasion, or both after obtaining the random access message. The operations of block 1820 may be performed in accordance with examples as disclosed herein. In some examples, aspects of the operations of 1820 may be performed by a random access response message configuration component 1135 as described with reference to FIG. 11.

The following provides an overview of aspects of the present disclosure:

Aspect 1: A method for wireless communications by a UE, comprising: receiving a control message that comprises an index of a sub-band of a plurality of sub-bands of a virtual cell and a quantity of random access occasions associated with the sub-band; transmitting a random access message within a random access occasion of the quantity of random access occasions indicated by the control message; and receiving a random access response message that is associated with the index of the sub-band, the random access occasion, or both after transmitting the random access message.

Aspect 2: The method of aspect 1, wherein transmitting the random access message comprises: transmitting the random access message in accordance with a first index, wherein the first index is based at least in part on combining the quantity of random access occasions with one or more second quantities of random access occasions associated with one or more second sub-bands.

Aspect 3: The method of aspect 2, further comprising: selecting a second index of the random access occasion based at least in part on the index of the sub-band and the quantity of random access occasions, wherein the first index is based at least in part on combining the second index with the combined quantity of random access occasions, and wherein the second index is a sub-band specific index and the first index is a non-sub-band specific index.

Aspect 4: The method of any of aspects 2 through 3, further comprising: transmitting the random access message in accordance with a temporary identifier, the temporary identifier being associated with a first type of random access procedure and the first index, wherein the temporary identifier is different than one or more second temporary identifiers associated with a second type of random access procedure based at least in part on the first index.

Aspect 5: The method of any of aspects 1 through 4, wherein receiving the random access response message comprises: receiving a second control message associated with the random access response message based at least in part on transmitting the random access message, wherein the random access response message is associated with the index of the sub-band, the random access occasion, or both based at least in part on receiving the second control message.

Aspect 6: The method of aspect 5, wherein the second control message comprises one or more fields that indicate the index of the sub-band, the random access occasion, or both.

Aspect 7: The method of any of aspects 5 through 6, further comprising: decoding the second control message in accordance with the index of the sub-band, the random access occasion, or both based at least in part on one or more cyclic redundancy check bits of the second control message, a reference signal scrambling identifier of the second control message, a bit interleaving pattern of the second control message, or any combination thereof, wherein receiving the random access response message is based at least in part on decoding the second control message.

Aspect 8: The method of any of aspects 1 through 7, wherein receiving the random access response message comprises: receiving, via the random access response message, an indication of the index of the sub-band, an indication of the random access occasion, or both.

Aspect 9: The method of aspect 8, wherein receiving the indication comprises: receiving the indication of the index of the sub-band, the indication of the random access occasion of the random access response message, or both via a medium access control header of the random access response message, a medium access control payload, one or more padding bits of the random access response message, a reference signal scrambling identifier of the random access response message, or a combination thereof.

Aspect 10: The method of any of aspects 1 through 9, wherein receiving the random access response message comprises: receiving the random access response message in accordance with the index of the sub-band, the random access occasion, or both based at least in part on first information included in a second control message associated with the random access response message and second information included in the random access response message.

Aspect 11: The method of any of aspects 1 through 10, wherein the quantity of random access occasions is based at least in part on a type of random access procedure.

Aspect 12: The method of any of aspects 1 through 11, wherein at least a first sub-band of the plurality of sub-bands and a second sub-band of the plurality of sub-bands are non-contiguous in a frequency domain.

Aspect 13: A method for wireless communications by a network entity, comprising: outputting a control message that comprises an index of a sub-band of a plurality of sub-bands of a virtual cell and a quantity of random access occasions associated with the sub-band; obtaining a random access message within a random access occasion of the quantity of random access occasions indicated by the control message; and outputting, to a UE, a random access response message that is associated with the index of the sub-band, the random access occasion, or both after obtaining the random access message.

Aspect 14: The method of aspect 13, wherein obtaining the random access message comprises: obtaining the random access message in accordance with a first index, wherein the first index is based at least in part on a combination of the quantity of random access occasions with one or more second quantities of random access occasions associated with one or more second sub-bands.

Aspect 15: The method of aspect 14, wherein the first index is based at least in part on a combination of a second index of the random access occasion and the combined quantity of random access occasions, the second index based at least in part on the index of the sub-band and the quantity of random access occasions, and the second index is a sub-band specific index and the first index is a non-sub-band specific index.

Aspect 16: The method of any of aspects 14 through 15, further comprising: obtaining the random access message in accordance with a temporary identifier, the temporary identifier being associated with a first type of random access procedure and the first index, wherein the temporary identifier is different than one or more second temporary identifiers associated with a second type of random access procedure based at least in part on the first index.

Aspect 17: The method of any of aspects 13 through 16, wherein outputting the random access response message comprises: outputting a second control message associated with the random access response message based at least in part on obtaining the random access message, wherein the random access response message is associated with the index of the sub-band, the random access occasion, or both based at least in part on outputting the second control message.

Aspect 18: The method of aspect 17, wherein the second control message comprises one or more fields that indicate the index of the sub-band, the random access occasion, or both.

Aspect 19: The method of any of aspects 17 through 18, further comprising: encoding the second control message in accordance with the index of the sub-band, the random access occasion, or both based at least in part on one or more cyclic redundancy check bits of the second control message, a reference signal scrambling identifier of the second control message, a bit interleaving pattern of the second control message, or any combination thereof.

Aspect 20: The method of any of aspects 13 through 19, wherein outputting the random access response message comprises: outputting, via the random access response message, an indication of the index of the sub-band, an indication of the random access occasion, or both.

Aspect 21: The method of aspect 20, wherein outputting the indication comprises: outputting the indication of the index of the sub-band, the indication of the random access occasion of the random access response message, or both via a medium access control header of the random access response message, a medium access control payload, one or more padding bits of the random access response message, a reference signal scrambling identifier of the random access response message, or a combination thereof.

Aspect 22: The method of any of aspects 13 through 21, wherein outputting the random access response message comprises: outputting the random access response message in accordance with the index of the sub-band, the random access occasion, or both based at least in part on including first information in a second control message associated with the random access response message and second information in the random access response message.

Aspect 23: The method of any of aspects 13 through 22, wherein the quantity of random access occasions is based at least in part on a type of random access procedure.

Aspect 24: The method of any of aspects 13 through 23, wherein at least a first sub-band of the plurality of sub-bands and a second sub-band of the plurality of sub-bands are non-contiguous in a frequency domain.

Aspect 25: A UE for wireless communications, comprising one or more memories storing processor-executable code, and one or more processors coupled with the one or more memories and individually or collectively operable to execute the code to cause the UE to perform a method of any of aspects 1 through 12.

Aspect 26: A UE for wireless communications, comprising at least one means for performing a method of any of aspects 1 through 12.

Aspect 27: A non-transitory computer-readable medium storing code for wireless communications, the code comprising instructions executable by one or more processors to perform a method of any of aspects 1 through 12.

Aspect 28: A network entity for wireless communications, comprising one or more memories storing processor-executable code, and one or more processors coupled with the one or more memories and individually or collectively operable to execute the code to cause the network entity to perform a method of any of aspects 13 through 24.

Aspect 29: A network entity for wireless communications, comprising at least one means for performing a method of any of aspects 13 through 24.

Aspect 30: A non-transitory computer-readable medium storing code for wireless communications, the code comprising instructions executable by one or more processors to perform a method of any of aspects 13 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message that comprises an index of a sub-band of a plurality of sub-bands of a virtual cell and a quantity of random access occasions associated with the sub-band;
transmit a random access message within a random access occasion of the quantity of random access occasions indicated by the control message; and
receive a random access response message that is associated with the index of the sub-band, the random access occasion, or both after transmitting the random access message.

2. The UE of claim 1, wherein, to transmit the random access message, the one or more processors are individually or collectively operable to execute the code to cause the UE to:
transmit the random access message in accordance with a first index, wherein the first index is based at least in part on combining the quantity of random access occasions with one or more second quantities of random access occasions associated with one or more second sub-bands.

3. The UE of claim 2, wherein the one or more processors are individually or collectively further operable to execute the code to cause the UE to:
select a second index of the random access occasion based at least in part on the index of the sub-band and the quantity of random access occasions, wherein the first index is based at least in part on combining the second index with the combined quantity of random access occasions, and wherein the second index is a sub-band specific index and the first index is a non-sub-band specific index.

4. The UE of claim 2, wherein the one or more processors are individually or collectively further operable to execute the code to cause the UE to:
transmit the random access message in accordance with a temporary identifier, the temporary identifier being associated with a first type of random access procedure and the first index, wherein the temporary identifier is different than one or more second temporary identifiers associated with a second type of random access procedure based at least in part on the first index.

5. The UE of claim 1, wherein, to receive the random access response message, the one or more processors are individually or collectively operable to execute the code to cause the UE to:
receive a second control message associated with the random access response message based at least in part on transmitting the random access message, wherein the random access response message is associated with the index of the sub-band, the random access occasion, or both based at least in part on receiving the second control message.

6. The UE of claim 5, wherein the second control message comprises one or more fields that indicate the index of the sub-band, the random access occasion, or both.

7. The UE of claim 5, wherein the one or more processors are individually or collectively further operable to execute the code to cause the UE to:
decode the second control message in accordance with the index of the sub-band, the random access occasion, or both based at least in part on one or more cyclic redundancy check bits of the second control message, a reference signal scrambling identifier of the second control message, a bit interleaving pattern of the second control message, or any combination thereof, wherein receiving the random access response message is based at least in part on decoding the second control message.

8. The UE of claim 1, wherein, to receive the random access response message, the one or more processors are individually or collectively operable to execute the code to cause the UE to:
receive, via the random access response message, an indication of the index of the sub-band, an indication of the random access occasion, or both.

9. The UE of claim 8, wherein, to receive the indication, the one or more processors are individually or collectively operable to execute the code to cause the UE to:
receive the indication of the index of the sub-band, the indication of the random access occasion of the random access response message, or both via a medium access control header of the random access response message, a medium access control payload, one or more padding bits of the random access response message, a reference signal scrambling identifier of the random access response message, or a combination thereof.

10. The UE of claim 1, wherein, to receive the random access response message, the one or more processors are individually or collectively operable to execute the code to cause the UE to:
receive the random access response message in accordance with the index of the sub-band, the random access occasion, or both based at least in part on first information included in a second control message associated with the random access response message and second information included in the random access response message.

11. The UE of claim 1, wherein the quantity of random access occasions is based at least in part on a type of random access procedure.

12. The UE of claim 1, wherein at least a first sub-band of the plurality of sub-bands and a second sub-band of the plurality of sub-bands are non-contiguous in a frequency domain.

13. A network entity, comprising:
one or more memories storing processor-executable code; and
one or more processors coupled with the one or more memories and individually or collectively operable to execute the code to cause the network entity to:
output a control message that comprises an index of a sub-band of a plurality of sub-bands of a virtual cell and a quantity of random access occasions associated with the sub-band;
obtain a random access message within a random access occasion of the quantity of random access occasions indicated by the control message; and
output, to a user equipment (UE), a random access response message that is associated with the index of the sub-band, the random access occasion, or both after obtaining the random access message.

14. The network entity of claim 13, wherein, to obtain the random access message, the one or more processors are individually or collectively operable to execute the code to cause the network entity to:
obtain the random access message in accordance with a first index, wherein the first index is based at least in part on a combination of the quantity of random access occasions with one or more second quantities of random access occasions associated with one or more second sub-bands.

15. The network entity of claim 14, wherein:
the first index is based at least in part on a combination of a second index of the random access occasion and the combined quantity of random access occasions, the second index based at least in part on the index of the sub-band and the quantity of random access occasions, and
the second index is a sub-band specific index and the first index is a non-sub-band specific index.

16. The network entity of claim 14, wherein the one or more processors are individually or collectively further operable to execute the code to cause the network entity to:
obtain the random access message in accordance with a temporary identifier, the temporary identifier being associated with a first type of random access procedure and the first index, wherein the temporary identifier is different than one or more second temporary identifiers associated with a second type of random access procedure based at least in part on the first index.

17. The network entity of claim 13, wherein, to output the random access response message, the one or more processors are individually or collectively operable to execute the code to cause the network entity to:
output a second control message associated with the random access response message based at least in part on obtaining the random access message, wherein the random access response message is associated with the index of the sub-band, the random access occasion, or both based at least in part on outputting the second control message.

18. The network entity of claim 17, wherein the second control message comprises one or more fields that indicate the index of the sub-band, the random access occasion, or both.

19. The network entity of claim 17, wherein the one or more processors are individually or collectively further operable to execute the code to cause the network entity to:
encode the second control message in accordance with the index of the sub-band, the random access occasion, or both based at least in part on one or more cyclic redundancy check bits of the second control message, a reference signal scrambling identifier of the second control message, a bit interleaving pattern of the second control message, or any combination thereof.

20. The network entity of claim 13, wherein, to output the random access response message, the one or more processors are individually or collectively operable to execute the code to cause the network entity to:
output, via the random access response message, an indication of the index of the sub-band, an indication of the random access occasion, or both.

21. The network entity of claim 20, wherein, to output the indication, the one or more processors are individually or collectively operable to execute the code to cause the network entity to:
output the indication of the index of the sub-band, the indication of the random access occasion of the random access response message, or both via a medium access control header of the random access response message, a medium access control payload, one or more padding bits of the random access response message, a reference signal scrambling identifier of the random access response message, or a combination thereof.

22. The network entity of claim 13, wherein, to output the random access response message, the one or more processors are individually or collectively operable to execute the code to cause the network entity to:
output the random access response message in accordance with the index of the sub-band, the random access occasion, or both based at least in part on including first information in a second control message associated with the random access response message and second information in the random access response message.

23. The network entity of claim 13, wherein the quantity of random access occasions is based at least in part on a type of random access procedure.

24. The network entity of claim 13, wherein at least a first sub-band of the plurality of sub-bands and a second sub-band of the plurality of sub-bands are non-contiguous in a frequency domain.

25. A method for wireless communications by a user equipment (UE), comprising:
receiving a control message that comprises an index of a sub-band of a plurality of sub-bands of a virtual cell and a quantity of random access occasions associated with the sub-band;
transmitting a random access message within a random access occasion of the quantity of random access occasions indicated by the control message; and
receiving a random access response message that is associated with the index of the sub-band, the random access occasion, or both after transmitting the random access message.

26. The method of claim 25, wherein transmitting the random access message comprises:
transmitting the random access message in accordance with a first index, wherein the first index is based at least in part on combining the quantity of random access occasions with one or more second quantities of random access occasions associated with one or more second sub-bands.

27. The method of claim 26, further comprising:
selecting a second index of the random access occasion based at least in part on the index of the sub-band and the quantity of random access occasions, wherein the first index is based at least in part on combining the second index with the combined quantity of random access occasions, and wherein the second index is a sub-band specific index and the first index is a non-sub-band specific index.

28. A method for wireless communications by a network entity, comprising:
outputting a control message that comprises an index of a sub-band of a plurality of sub-bands of a virtual cell and a quantity of random access occasions associated with the sub-band;
obtaining a random access message within a random access occasion of the quantity of random access occasions indicated by the control message; and
outputting, to a user equipment (UE), a random access response message that is associated with the index of the sub-band, the random access occasion, or both after obtaining the random access message.

29. The method of claim 28, wherein obtaining the random access message comprises:
obtaining the random access message in accordance with a first index, wherein the first index is based at least in part on a combination of the quantity of random access occasions with one or more second quantities of random access occasions associated with one or more second sub-bands.

30. The method of claim 29, wherein the first index is based at least in part on a combination of a second index of the random access occasion and the combined quantity of random access occasions, the second index based at least in part on the index of the sub-band and the quantity of random access occasions, and the second index is a sub-band specific index and the first index is a non-sub-band specific index.
